(19) United States
(12) Patent Application Publication
(10) Pub. No.: US 2026/0104873 A1
(43) Pub. Date: Apr. 16, 2026

(54) HARDWARE ASSISTED BINARY TRANSLATION WITHIN VIRTUALIZATION ENVIRONMENTS

(71) Applicant: PARALLELS INTERNATIONAL GMBH, SCHAFFHAUSEN (CH)

(72) Inventors: ALEXEY KORYAKIN, MOSCOW (RU); ANDREY STUPACHENKO, MOSCOW (RU); ALEKSANDR ERMISHECHKIN, MOSCOW (RU); ASHOT AVAGYAN, MOSCOW (RU)

(21) Appl. No.: 19/078,584

(22) Filed: Mar. 13, 2025

Related U.S. Application Data
(60) Provisional application No. 63/707,610, filed on Oct. 15, 2024.

(51) Int. Cl. G06F 8/41; G06F 9/455; G06F 12/1009

(52) U.S. Cl. CPC G06F 8/447; G06F 9/455; G06F 12/1009

(57) ABSTRACT

Modern processor hardware virtualization capabilities allow for organizing a virtual environment to run on the same processor architecture guest operating system code without modifications right on central processing unit. However, incompatible architecture guest operating code cannot be launched as is under existing hardware assisted virtualization software. Accordingly, there are provided systems and methods employing hardware assisted binary translation within virtualized environments to support these requirements of incompatible architecture guest operating code by isolating the guest operating system architecture offering enhanced execution.

### CROSS-REFERENCE TO RELATED APPLICATIONS

This patent application claims the benefit of priority to U.S. Provisional Patent Application 63/707,610 filed Oct. 15, 2024; the entire contents of which are incorporated herein by reference.

### FIELD OF THE INVENTION

This patent application relates to virtualization environments and more particularly to methods and systems to enhance execution of the guest operating system and software applications by exploiting hardware assisted binary translation for the virtualization environment or virtualization environments.

### BACKGROUND OF THE INVENTION

Virtualized environments have become increasingly common in the past decade for providing users with software applications executing within a guest operating system (guest OS) rather than the host operating system (host OS) of a server or desktop or providing users with remote access to computer services, resources and software application upon remote servers.

Virtualized environments via virtualization software emulating guest OS exploit hypervisor technology which maps a virtual machine's resources directly to the host computer's hardware resources directly. Accordingly, each virtual machine thus operates identically to a standalone computer, with virtually all the resources of a physical computer. From the user's use perspective the benefits of virtual machines and virtualization environments are only realized when these virtualized environments operate efficiently without significant performance degradation. From the perspective of software-as-a-service providers of virtualization environments to users it would be beneficial to isolate the guest operating system on all levels from applications executing upon it to its kernel.

Modern processor hardware virtualization capabilities like Intel VT-x, AMD-V, ARM Hypervisor mode allow to organize virtual environment to run same processor architecture guest OS code without modifications right on CPU. That is guest Intel ×86 code can run natively on Intel CPU with enabled hardware-assisted virtualization VT-x technology. The same is true for guest ARM code running under control of Hypervisor software running in ARM Hypervisor mode. Unfortunately, incompatible architecture guest OS code cannot be launched as is under hardware assisted virtualization software. Accordingly, the inventors have established systems and methods employing hardware assisted binary translation within virtualized environments to support these requirements of isolating guest operating system architecture and enhanced execution as well as other benefits which will be evident from the detailed description.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to virtualization environments and more particularly to providing methods and systems for enhanced execution of the guest operating system and software applications by exploiting hardware assisted binary translation for the virtualization environment or virtualization environments.

In accordance with an embodiment of the invention there is provided a method comprising: creation of a hardware assisted virtualized environment for running incompatible guest operating system code by:
establishing native mapping of a guest virtual address space to virtual addresses of a host CPU; and
generating translated code for incompatible guest to native host instructions.

In accordance with an embodiment of the invention there is provided a system comprising: at least a host CPU; wherein
the host CPU supports creation of a hardware assisted virtualized environment for running incompatible guest operating system code by:
   establishing native mapping of a guest virtual address space to virtual addresses of a host CPU; and
   generating translated code for incompatible guest to native host instructions.

In accordance with an embodiment of the invention there is provided a method comprising:
mapping guest code execution to a single kernel level context controlled by virtualization software within a hardware-assisted virtualization mode.

In accordance with an embodiment of the invention there is provided a system comprising:
a host CPU; wherein
the host CPU executes a process for mapping guest code execution to a single kernel level context controlled by virtualization software within a hardware-assisted virtualization mode.

In accordance with an embodiment of the invention there is provided a method comprising: establishing a paging cache organization for an incompatible code architecture running under hardware-assisted virtualization control upon a system.

In accordance with an embodiment of the invention there is provided a system comprising:
a host CPU; wherein
the host CPU executes multiple processes of which one establishes a paging cache organization for an incompatible code architecture running under hardware-assisted virtualization control upon a system.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary electronic device and network supporting embodiments of the invention;

FIG. 2 depicts an exemplary block diagram of a system for initiating or transferring a remote access session between a mobile client and/or a client device and a remote access system supporting embodiments of the invention;

FIG. 3A schematically depicts an architecture of virtual machines as instantiated by remote access sessions supporting embodiments of the invention;

FIG. 3B depicts a high-level diagram of a computer system supporting exemplary virtual machine execution environments supporting one or more aspects and/or embodiments of the invention;

FIG. 4A schematically depicts virtual space isolation of operating system processes for virtual machines according to the prior art;

FIG. 4B schematically depicts the emulation of guest operating system processes for virtual machines according to the prior art;

FIG. 4C depicts schematically hardware assisted virtualization of guest operating system processes for virtual machines running under control of one of a Hypervisor, Hypervisor with Virtual Machine Manager (VMM) or Thin Hypervisor with user-space VMM according to the prior art;

FIG. 5A depicts schematically a virtualization environment exploiting hardware assisted binary translation according to an embodiment of the invention;

FIG. 5B depicts schematically a virtualization environment exploiting hardware assisted binary translation according to an embodiment of the invention;

FIG. 5C depicts a schematic of the virtualized guest operating system within the embodiment of the invention depicted in FIG. 5B;

FIG. 6 depicts schematically the processing engines within an emulation kernel supporting embodiments of the invention and their functions; and

FIG. 7 depicts a process flow for a switching paging cache branches to handle a transition between applications within an embodiment of the invention.

### DETAILED DESCRIPTION

The present description is directed to virtualization environments and more particularly to methods and systems to enhance execution of the guest operating system and software applications by exploiting hardware assisted binary translation for the virtualization environment or virtualization environments.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers, or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein may refer to, but is not limited to, a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, fitness tracker and an electronic reader.

A “fixed electronic device” (FED) as used herein may refer to, but is not limited to, a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” or “wearable sensor” (Wearable Device) as used herein may refer to, but is not limited to, an electronic device that is worn by a user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

A “client device” as used herein may refer to, but is not limited to, a PED, FED or Wearable Device upon which a user can access directly a file or files which are stored locally upon the PED, FED or Wearable Device, which are referred to as “local files”, and/or a file or files which are stored remotely to the PED, FED or Wearable Device, which are referred to as “remote files”, and accessed through one or more network connections or interfaces to a storage device.

A “server” as used herein may refer to, but is not limited to, one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

A “software application” (commonly referred to as an “application” or “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “graphical user interface” (GUI) as used herein may refer to, but is not limited to, a form of user interface for a PED, FED, Wearable Device, software application or operating system which allows a user to interact through graphical icons with or without an audio indicator for the selection of features, actions, etc. rather than a text-based user interface, a typed command label or text navigation.

An “enterprise” as used herein may refer to, but is not limited to, a provider of a service and/or a product to a user, customer, or consumer and may include, but is not limited to, a retailer, an online retailer, a market, an online marketplace, a manufacturer, a utility, a Government organization, a service provider, and a third party service provider.

A “service provider” as used herein may refer to, but is not limited to, a provider of a service and/or a product to an enterprise and/or individual and/or group of individuals and/or a device comprising a microprocessor.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of organizations, men, and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“Biometric” data or biometric information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

Within the following description references are made to Intel, AMD and ARM microprocessors and architectures in order to demonstrate how the invention is implemented for real processor architectures. However, embodiments of the invention are not limited to these architectures and may be applied with a processor architecture supporting hardware capabilities of virtual to physical address translation and hardware modes for system and user code execution.

Within the following description embodiments of the invention are described with respect to the technology operating or functioning upon a dedicated computer system. However, it would be evident to one of skill in the art that the embodiments of the invention function whether the computer system is standalone or as part of wider distributed and/or remote computer system installation as in each instance the invention functions are isolated within a single host.

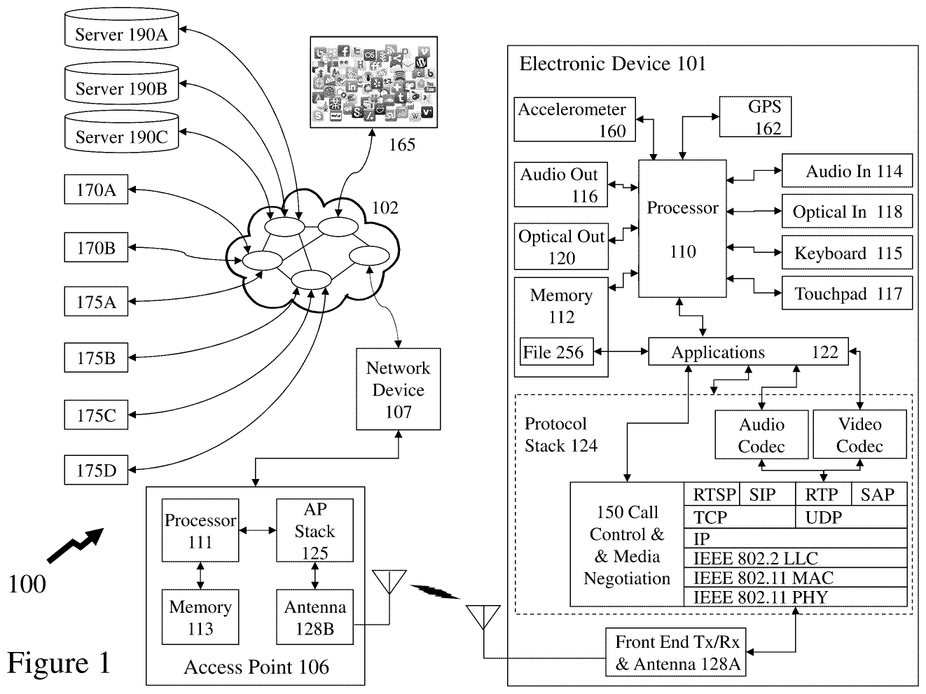

Now referring to FIG. 1 there is depicted a schematic 100 of a network to which an Electronic Device 101 supporting Remote Access System (RAS) Systems, Applications and Platforms (SAPs) and RAS-SAP features according to embodiments of the invention is connected. Electronic Device 101 may, for example, be a PED, a FED, or a wearable device and may include additional elements beyond those described and depicted. Also depicted in conjunction with the Electronic Device 101 are exemplary internal and/or external elements forming part of a simplified functional diagram of an Electronic Device 101 within an overall simplified schematic of a system supporting SAP features according to embodiments of the invention which include includes an Access Point (AP) 106, such as a Wi-Fi AP for example, a Network Device 107, such as a communication server, streaming media server, and a router. The Network Device 107 may be coupled to the AP 106 via any combination of networks, wired, wireless and/or optical communication links. Also connected to the Network 102 are Social Media Networks (SOCNETS) 165; first and second remote systems 170A and 170B respectively; first and second websites 175A and 175B respectively; first and third 3rd party service providers 175C and 175E respectively; and first to third servers 190A to 190C respectively.

The Electronic device 101 includes one or more Processors 110 and a Memory 112 coupled to Processor(s) 110. AP 106 also includes one or more Processors 111 and a Memory 113 coupled to Processor(s) 210. A non-exhaustive list of examples for any of Processors 110 and 111 includes a central processing unit (CPU), a digital signal processor (DSP), a reduced instruction set computer (RISC), a complex instruction set computer (CISC), a graphics processing unit (GPU) and the like. Furthermore, any of Processors 110 and 111 may be part of application specific integrated circuits (ASICs) or may be a part of application specific standard products (ASSPs). A non-exhaustive list of examples for Memories 112 and 113 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

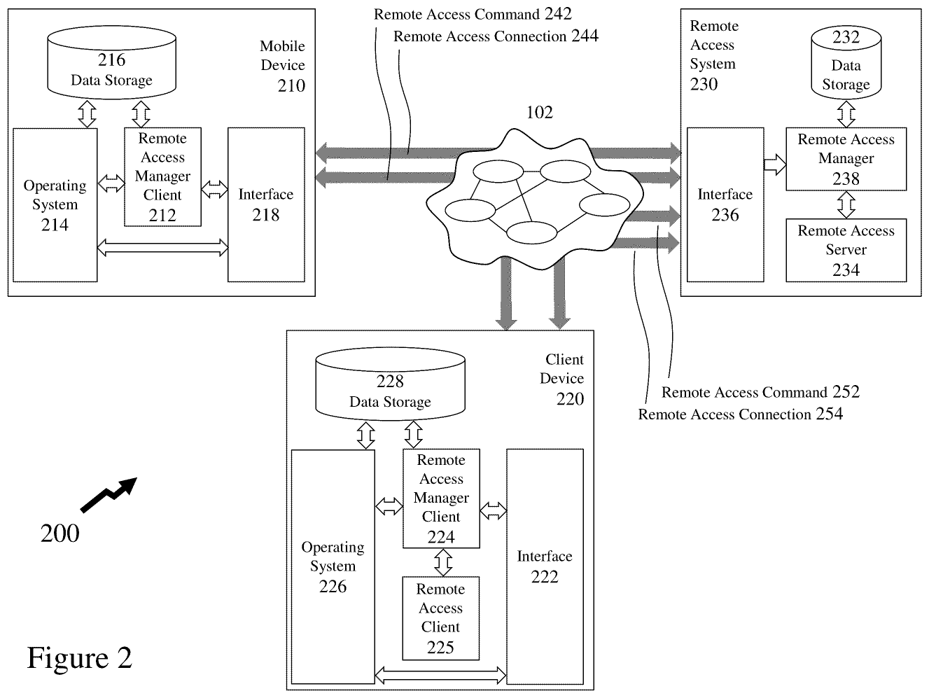

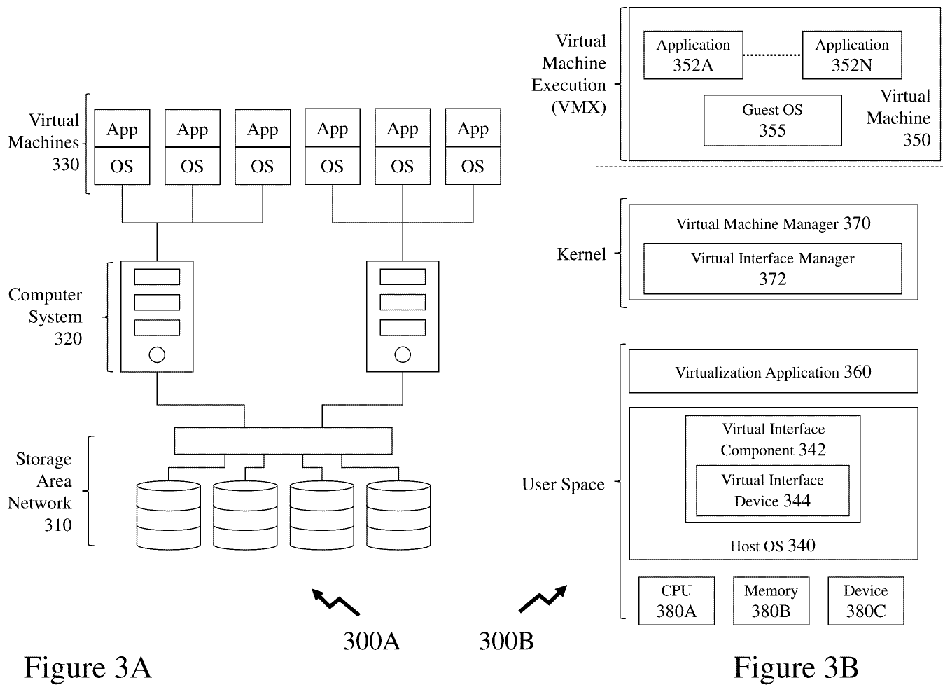

Electronic Device 101 may include an audio input element 214, for example a microphone, and an Audio Output Element 116, for example, a speaker, coupled to any of Processor(s) 110. Electronic Device 101 may include an Optical Input Element 218, for example, a video camera or camera, and an Optical Output Element 220, for example an LCD display, coupled to any of Processor(s) 110. Electronic Device 101 also includes a Keyboard 115 and Touchpad 117 which may for example be a physical keyboard and touchpad allowing the user to enter content or select functions within one of more Applications 122. Alternatively, the Keyboard 115 and Touchpad 117 may be predetermined regions of a touch sensitive element forming part of the display within the Electronic Device 101. The one or more Applications 122 that are typically stored in Memory 112 and are executable by any combination of Processor(s) 110. Electronic Device 101 also includes Accelerometer 160 providing three-dimensional motion input to the Processor(s) 110 and GPS 162 which provides geographical location information to Processor(s) 110. as described and depicted below in respect of FIGS. 2 and 3 respectively an Application 122 may support communications with a remote access system allowing one or more remote sessions to be established each associated with one or more Virtual Machines (VMs) allowing non-native applications (e.g. those requiring an Operating System (OS) different to that in execution upon the Processor 110) to be accessed and executed.

Electronic Device 101 includes a Protocol Stack 124 and AP 106 includes an AP Stack 125. Within Protocol Stack 124 is shown an IEEE 802.11 protocol stack but alternatively may exploit other protocol stacks such as an Internet Engineering Task Force (IETF) multimedia protocol stack for example or another protocol stack. Likewise, AP Stack 125 exploits a protocol stack but is not expanded for clarity. Elements of Protocol Stack 124 and AP Stack 125 may be implemented in any combination of software, firmware and/or hardware. Protocol Stack 124 includes an IEEE 802.11-compatible PHY module that is coupled to one or more Tx/Rx & Antenna Circuits 128A and an IEEE 802.11-compatible MAC module which is coupled to an IEEE 802.2-compatible LLC module. Protocol Stack 124 also includes modules for Network Layer IP, a transport layer User Datagram Protocol (UDP), a transport layer Transmission Control Protocol (TCP), a session layer Real Time Transport Protocol (RTP), a Session Announcement Protocol (SAP), a Session Initiation Protocol (SIP) and a Real Time Streaming Protocol (RTSP). Protocol Stack 124 includes a presentation layer Call Control and Media Negotiation module 150, one or more audio codecs and one or more video codecs. Applications 122 may be able to create maintain and/or terminate communication sessions with the Network Device 107 by way of AP 106 and therein via the Network 102 to one or more of Social Networks (SOCNETS) 165; first and second remote systems 170A and 170B respectively; first and second websites 175A and 175B respectively; first and third 3rd party service providers 175C and 175E respectively; and first to third servers 190A to 190C respectively. As described below in respect of FIGS. 2 and 3 a Remote Access System may be executed by and/or accessed by the Electronic Device 101 via the Network 102 on one or more of first and second websites 175A and 175B respectively; first and third 3rd party service providers 175C and 175E respectively; and first to third servers 190A to 190C respectively.

Typically, Applications 122 may activate any of the SAP, SIP, RTSP, and Call Control & Media Negotiation 150 modules for that purpose. Typically, information may propagate from the SAP, SIP, RTSP, Call Control & Media Negotiation 150 to the PHY module via the TCP module, IP module, LLC module and MAC module. It would be apparent to one skilled in the art that elements of the Electronic Device 101 may also be implemented within the AP 106 including but not limited to one or more elements of the Protocol Stack 124, including for example an IEEE 802.11-compatible PHY module, an IEEE 802.11-compatible MAC module, and an IEEE 802.2-compatible LLC module. The AP 106 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, and a call control & media negotiation module. Portable electronic devices (PEDs) and fixed electronic devices (FEDs) represented by Electronic Device 101 may include one or more additional wireless or wired interfaces in addition to or in replacement of the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1010, DSL, Dial-Up, DOCSIS, Ethernet, G.hn, ISDN, MoCA, PON, and Power line communication (PLC).

The Front End Tx/Rx & Antenna 128A wirelessly connects the Electronic Device 101 with the Antenna 128B on Access Point 206, wherein the Electronic Device 101 may support, for example, a national wireless standard such as GSM together with one or more local and/or personal area wireless protocols such as IEEE 802.11 a/b/g Wi-Fi, IEEE 802.16 WiMAX, and IEEE 802.15 Bluetooth for example. Accordingly, it would be evident to one skilled the art that the Electronic Device 101 may accordingly download original software and/or revisions for a variety of functions. In some embodiments of the invention the functions may not be implemented within the original as sold Electronic Device 101 and are only activated through a software/firmware revision and/or upgrade either discretely or in combination with a subscription or subscription upgrade for example. Accordingly, as will become evident in respect of the description below the Electronic Device 101 may provide a user with access to one or more RAS-SAPs including, but not limited to, software installed upon the Electronic Device 101 or software installed upon one or more remote systems such as those associated with Social Networks (SOCNETS) 165; first to fifth remote systems 170A to 170E respectively; first and second websites 175A and 175B respectively; and first to third 3rd party service provides 175C to 175E respectively; and first to third servers 190A to 190C respectively for example.

Accordingly, within the following description a remote system/server may form part or all of the Social Networks (SOCNETS) 165; first and second remote systems 170A and 170B respectively; first and second websites 175A and 175B respectively; first and third 3rd party service providers 175C and 175E respectively; and first to third servers 190A to 190C respectively. Within the following description a local client device may be Electronic Device 101 such as a PED, FED or Wearable Device and may be associated with one or more of the Social Networks (SOCNETS) 165; first and second remote systems 170A and 170B respectively; first and second websites 175A and 175B respectively; first and third 3rd party service providers 175C and 175E respectively; and first to third servers 190A to 190C respectively. Similarly, a storage system/server within the following descriptions may form part of or be associated within Social Networks (SOCNETS) 165; first and second remote systems 170A and 170B respectively; first and second websites 175A and 175B respectively; first and third 3rd party service providers 175C and 175E respectively; and first to third servers 190A to 190C respectively.

Now referring to FIG. 2 there is depicted a schematic diagram 200 depicting an exemplary configuration for initiating a remote access session for connecting a Mobile Device 210 to a Remote Access System 206 and/or a Client Device 220. As depicted the Mobile Device 210 is in communication with the Remote Access System 230 over a Network 102, such as a local area network (LAN), wide area network (WAN), or the Internet. Further, the Client Device 220 is in communication with the Remote Access System 230 over the Network 102. Optionally, the remote sessions of the Mobile Device 210 and the Client Device 220 are independent sessions. Optionally, within the Remote Access System 230 may transfer a session to the Client Device 220 when the Mobile Device 210 is in proximity to the Client Device 220 where the transferred session is either configured upon an existing established session or is established by the Client Device 220 in dependence upon a communication or communications from the Remote Access System 230. Optionally, the Remote Access System 230 may transfer a session to the Mobile Device 210 from the Client Device 220 when the Mobile Device 210 is initially in proximity to the Client Device 220 and then is moved out of proximity whilst the remote session is still active, where the transferred session is either configured upon an existing established session or is established by the Mobile Device 210 in dependence upon a communication or communications from the Remote Access System 230. The Mobile Device 210 and Client Device 220 may be associated with a common user or with different users. Optionally, the Remote Access System 230 may also host and/or initiate a remote access session at a predetermined time.

The Remote Access System 230 may include one or more computing devices that perform the operations of the Remote Access System 230 and may, for example, be a server such as first to third Servers 190A to 190C respectively individually or in combination. It would be evident that the Mobile Device 210 may be a PED, FED, or Wearable Device. Accordingly, with a session involving only the Mobile Device 210 and the Remote Access System 230 the session is established, maintained and terminated in dependence upon one or more Remote Access Commands 242 over a Remote Access Connection 244 between the Mobile Device 210 and the Remote Access System 230. Accordingly, with a session involving only the Client Device 220 and the Remote Access System 230 the session is established, maintained and terminated in dependence upon one or more Remote Access Commands 224 over a Remote Access Connection 254 between the Client Device 220 and the Remote Access System 230. When the session involves both the Mobile Device 210 and the Client Device 220 with the Remote Access Server then the session is established, maintained and terminated in dependence upon one or more Remote Access Commands 242 over a Remote Access Connection 244 between the Mobile Device 210 and the Remote Access System 230 and one or more Remote Access Commands 224 over a Remote Access Connection 254 between the Client Device 220 and the Remote Access System 230.

In each scenario one or more remote access sessions are established at the Remote Access System 230, either upon or in associated with a server such as first to third Servers 190A to 190C respectively in FIG. 1. The server, e.g. first Server 190A, may include one or more computing devices that perform the operations of the server. The server may be included in the Remote Access System 230 or another system that is separate and/or distinct from the Remote Access System 230 or the Remote Access System 230 may be in execution upon the server. A server application at the server initiates the one or more remote access sessions where initiating a remote access session may include, for example, executing boot-up and/or logon processes, such as running a script that automatically executes when the user logs in to the session, running applications from a folder designated as including applications to be automatically executed when the user logs in to the session, running services that automatically execute when the session starts and/or the user logs in to the session, and/or executing group policies or group policy preferences when the user logs in to the session. Alternatively, the remote access session may start the session and/or log in the user but only execute applications when these are triggered by one or more actions of the user upon the Mobile Device 210 and/or Client Device 220. In some implementations, the server application initiates the remote access session in response to determining that a remote access session has not already been initiated when a request from a device, e.g. Mobile Device 210 and/or Client Device 220, is received.

A remote access session may for example be an instance of a Virtual Machines 330 and 350 as described and depicted in FIGS. 3A and 3B respectively, is an instance of a user session or profile in execution upon the Remote Access System 230 which is accessed remotely at the Mobile Device 210 and/or Client Device 220 by a client application in execution upon the respective Mobile Device 210 and/or Client Device 220.

The Mobile Device 210 and/or Client Device 220 connects to the Remote Access System 230 and initiates either a new remote access session or accesses an established remote access session either in execution or suspended pending user re-initiation. The remote access session allows the Mobile Device 210 and/or Client Device 220 to access resources of the Remote Access System 230 and therein those of the server(s) forming part of server or server system associated with the Remote Access System 230, such as volatile memory (e.g., random access memory), persistent memory (e.g., a hard drive), a processor (e.g., a central processing unit (CPU) or a graphics processing unit (GPU)), a component or components of an operating system, or an application or applications such as Applications 352A to 352N respectively as depicted in FIG. 3B. One or more of these resources may be physical resources that are accessed through the remote access session (e.g., through a terminal service) and are either directly accessible to the Remote Access System 230 or accessible to the Remote Access System 230 via the Network 102 or another network to which the Remote Access System 230 is also connected. For example, the Remote Access System 230 may be in execution upon a server which forms part of a server farm wherein the Remote Access System 230 can access resources upon or associated with the other servers in the server farm. One or more of these resources may be virtual resources that are accessed through the remote access session (e.g., through remote desktop virtualization via a Virtual Machine). Optionally, the Remote Access System 230 may cause the Mobile Device 210 and/or Client Device 220 to connect to the remote access session, such that a user of the Mobile Device 210 and/or Client Device 220 may then use the remote access session to access the resources and/or applications of the server. Optionally, the user of the Mobile Device 210 and/or Client Device 220 may trigger the connection to the Remote Access System 230 to establish the remote access session so that the user of the Mobile Device 210 and/or Client Device 220 may then use the remote access session to access the resources and/or applications of the server.

Within embodiments of the invention the Mobile Device 210 and/or Client Device 220 may communicate with the Network 102 through a wireless connection, such as a terrestrial wireless communication system (e.g., a cellular data network or one or more Wi-Fi networks) or a satellite system for example. Alternatively, the Mobile Device 210 and/or Client Device 220 may communicate with the Network 102 through a wired connection, such as Ethernet or Internet over cable for example. Alternatively, the Mobile Device 210 and/or Client Device 220 may communicate with the Network 102 through a wireless connection such as depicted in FIG. 1 to a network access point (e.g. Access Point 106) and therein to the Network 102 via Network Device 107 or through a network access point directly to the Network 102.

A remote access session may be possible only within a predetermined geofence, e.g. a Mobile Device 210 associated with user of an enterprise can only successfully establish a remote access session if the Mobile Device 210 is within one or more geofences where each geofence is associated with a location of the enterprise and/or a residence of the user, for example. Similarly, Client Device 206 may be similarly geofenced such that movement of the Client Device 206 inside a geofence allows a remote access session to be established and movement of the Client Device 206 outside of the geofence prevents a remote session being established and/or terminates an existing remote session. The application(s) accessible to the user within a remote access session are determined by whether the Mobile Device 210 and/or Client Device 220 used by the user is within a geofence. A user may define the geofences themselves, e.g. their residence or set it to some default inaccessible geofence (e.g. one of zero radius or the North Pole for example) such that upon loss of the Mobile Device 210 and/or Client Device 220 access to application(s) and/or remote access sessions is prevented. The Mobile Device 210 and/or Client Device 220 may determine their location by one or more means including, but not limited to, accessing a global positioning system (GPS, such as GPS receiver 162 as depicted in FIG. 1), by triangulation with or proximity to signals from one or more antennas with known locations, such as cellular data network towers in a cellular data network or Wi-Fi devices in the Wi-Fi networks. Optionally, the Mobile Device 210 and/or Client Device 220 may establish its location by communicating with another device in its proximity, e.g. a Mobile Device 210 without a GPS may establish a personal area network connection to another device, e.g. a smartphone of the user, and therein obtain its location.

As depicted in FIG. 2 the Mobile Device 210 includes one or more Interfaces 218 to communicate with the Network 102, such as wireless interfaces to a cellular data network, a Wi-Fi network, and/or a satellite system, for example, or a wired interface to an Internet Router, for example. The Mobile Device 210 includes a Remote Access Manager Client 212 that communicates with an Operating System 214 of the Mobile Device 210, for example, to determine a location of the Mobile Device 210 or access one or more applications. an application in execution upon the Mobile Device 210 may trigger the Remote Access Manager Client 212 to access the Remote Access System 230. The Remote Access Manager Client 212 and Operating System 214 can each access Data Storage 216.

Similarly, as depicted in FIG. 2 the Client Device 220 includes one or more Interfaces 222 to communicate with the Network 102, such as wireless interfaces to a cellular data network, a Wi-Fi network, and/or a satellite system, for example, or a wired interface to an Internet Router, for example. The Client Device 220 includes a Remote Access Manager Client 224 that communicates with an Operating System 226 of the Client Device 220, for example, to determine a location of the Client Device 220 or access one or more applications. an application in execution upon the Client Device 220 may trigger the Remote Access Manager Client 224 to access the Remote Access System 230. The Remote Access Manager Client 224 and Operating System 226 can each access Data Storage 216 whilst the Remote Access Manager Client 224 may also access or communicate with Remote Access Client 225.

Similarly, as depicted in FIG. 2 the Remote Access System 230 includes one or more Interfaces 236 to communicate with the Network 102 and a Remote Access Manager 238 which communicates with Data Storage 232 that stores information that identifies or relates to a remote access session associated with the Mobile Device 210 and/or Client Device 220. As depicted the Remote Access Manager 238 communicates via Remote Access Commands 242 over Remote Access Connection 244 between its Interface 236 and Interface 236 of the Mobile Device 210. Similarly, the Remote Access Manager 238 communicates via Remote Access Commands 224 over Remote Access Connection 254 between its Interface 236 and Interface 222 of the Client Device 220. Accordingly, the Mobile Device 210 and/or Client Device 220 can send a remote access command to the Remote Access System 230 to initiate and/or connect to a remote access session or the Remote Access System can send a remote access command to Mobile Device 210 and/or Client Device 220 to initiate and/or connect to a remote access session.

As depicted in FIG. 2 the Remote Access System 230 in addition to the Remote Access Manager 238 and Data Storage 232 includes a Remote Access Server 234 which is hosted at a server that may include one or more computing devices. The server may be included in the Remote Access System 230 or be a system that is separate and/or distinct from the Remote Access System 230. The Remote Access Manager 238 may cause the Remote Access Server 234 to initiate a remote access session. Once connected, a user of the Mobile Device 210 may access resources provided by the server through the Remote Access Connection 244 to the remote access session or a user of the Client Device 220 may access resources provided by the server through the Remote Access Connection 254 to the remote access session.

Within some implementations, the Remote Access Manager Client 212 at the Mobile Device 210 and/or the Remote Access Manager Client 224 at the Client Device 220 receive an input from a user, device, and/or application that includes authentication information, such as a username, password, and/or one-time password. The Remote Access Manager Client 212 and/or the Remote Access Manager Client 224 may provide the authentication information to the Remote Access Manager 238. The Remote Access Manager 238 may condition the sending of the Remote Access Command 242 on having successfully verified authentication information received from the Mobile Device 210 or Remote Access Command 252 on having successfully verified authentication information received from the Client Device 220. This verification, being for example, against corresponding authentication information that is stored at the Remote Access System 230 in the Data Storage 232 or another memory accessible to the Remote Access System 230 (e.g., a username and/or password) and/or calculated by the Remote Access Manager 238 (e.g., a one-time password). In some implementations, the authentication information may include information from a scanner/device, such as biometric data from a biometric scanner and/or biometric device (e.g. a fingerprint, facial scanner, or credential data of the user from a card scanner and/or reader device (e.g. as employed for access control), associated with the Mobile Device 210 and/or Client Device 220 or a location such as a worksite, office, enterprise access point etc. The information provided to the Remote Access System 230 by the Mobile Device 210 and/or Client Device 220 retrieved from the scanner/device may also include information that identifies a user account associated with the successful verification of the user or is retrieved from another system in dependence upon the information retrieved from the scanner/device. This information may be provided as obtained or as processed by a system such as the user's electronic device, e.g. Mobile Device 210 or Client Device 220. This information provided to the Remote Access System 230 may also include information that identifies the scanner/device as well as time and/or date of the information being acquired and/or geographic location information of the scanner/device location, Such a verification providing an alternate means of restricting remote access sessions and/or application executable within a remote access session to geofencing.

In response to successfully verifying the received authentication information, the Remote Access Manager 238 may perform a transformation on the received authentication information and/or additional information, such as by creating a hash of the information, to generate a key. The Remote Access Manager 238 may provide the key to the Remote Access Manager Client 212 at the Mobile Device 210 and/or the Remote Access Manager Client 224 at the Client Device 220. The Remote Access Manager Client 212 may store the key in a Data Storage 216 at the Mobile Device 210. The Remote Access Manager Client 224 may store the key in a Data Storage 228 at the Client Device 220. Alternatively, the Remote Access Manager Client 212 and/or the Remote Access Manager Client 224 may perform a transformation on the authentication information and/or additional information to generate the key and store the key in the Data Storage 216 and/or the Data Storage 228, respectively. The Remote Access Manager Client 212 may provide the key and/or a reverse of the transformation of the key to the Remote Access System 230 for authentication of the Mobile Device 210 by the Remote Access System 230. The Remote Access Manager Client 224 may provide the key and/or a reverse of the transformation of the key to the Remote Access System 230 with subsequent checks for remote access commands for authentication of the Client Device 220 by the Remote Access System 230. The communications between the Mobile Device 210, the Remote Access System 230, and/or the Client Device 220 over the Network 102 may be encrypted.

The authentication information used for authenticating the Remote Access Manager Client 224 at the Client Device 220 with the Remote Access Manager 238 at the Remote Access System 230 may be the same authentication information that is used to authenticate the Remote Access Client 225 with the Remote Access Server 234 or alternatively it may be separate and/or distinct.

In response to the Remote Access Manager Client 224 receiving the Remote Access Command 254, the Remote Access Manager Client 224 may instruct the Remote Access Client 225 to connect to the remote access session provided by the Remote Access Server 234 in the background of a user profile for the Client Device 220. Optionally, a user interface of the Client Device 220 may be locked requiring the user to provide authentication information to the Client Device 220 to unlock the user interface for the user profile where the Remote Access Client 225 establishes the Remote Access Connection 244 to the remote access session. Similarly, Remote Access Manager Client 212 receiving the Remote Access Command 242, the Remote Access Manager Client 212 may connect to the remote access session provided by the Remote Access Server 234 in the background of a user profile for the Mobile Device 210. Optionally, a user interface of the Mobile Device 210 may be locked requiring the user to provide authentication information to the Mobile Device 210 to unlock the user interface for the user profile where the Remote Access Manager Client 212 establishes the Remote Access Connection 254 to the remote access session.

The Remote Access Manager 238 may send a command to the Remote Access Server 234 to disconnect from a remote access session, for example, once the Remote Access Manager 238 has verified that the Remote Access Server 234 has completed a remote access session or upon receiving a Remote Access Command 242 from Mobile Device 210 or Remote Access Command 254 from Client Device 220 to terminate a remote access session, the Remote Access Manager 238 and/or Remote Access Server 234 may receive a Remote Access Command 242 from Mobile Device 210 or Remote Access Command 254 from Client Device 220 to log-off a remote access session such that the associated Remote Access Connection 244 or 232 is terminated but the processing upon the Remote Access System 230 and/or Remote Access Server 234 is not terminated. Accordingly, a remote access session may be initiated to establish a process, e.g. a numerical simulation within a computer aided design application, where the connection is not required to be maintained until the user wishes to access the results of the process. Similarly, the Remote Access Manager 238 and/or Remote Access Server 234 may receive a Remote Access Command 242 from Mobile Device 210 or Remote Access Command 254 from Client Device 220 to suspend a remote access session such that the associated Remote Access Connection 244 or 232 is terminated and the processing upon the Remote Access System 230 and/or Remote Access Server 234 suspended pending subsequent re-initiation of the remote access session.

Referring to FIG. 3A there is depicted a schematic architecture 300A supporting embodiments of the invention. As depicted a plurality of virtual machines (VMs) 130 are associated with a plurality of Computer Systems 320 which are themselves associated with a storage area network (SAN) 310. The plurality of Computer Systems 320 may be directly connected or indirectly connected via one or more communications networks to the 310, such as Network 102 in FIGS. 1 and 2. Accordingly, each VM 130 may employ virtual memory pages which are mapped to physical memory pages upon the 310. A Computer System 320 may be connected to one or more SANs 110. Whilst the descriptions in respect of FIGS. 3A to 3B are described with respect to a Computer System 320 hosting one or more VMs 330 it would be evident that these may be supported by a PED, a FED, a WED, a server or a WES directly or indirectly through communications within one of the plurality of Computer Systems 320. A computer system 320 may itself be a PED, a FED, a WED, a server, or a WES. Accordingly, a computer system 320 may, as depicted in FIG. 3B, support a virtual machine execution (VMX) environment as a host system directly or indirectly or it may include a virtual machine manager (VMM) facilitating execution of one or more VMs, each of which may, as depicted in FIG. 3B, run a guest operating system (OS) 355 to manage one or more Guest Applications 352A to 352N respectively. Accordingly, a Computer System 320 may be a Remote Access System 230 and SAN 310 may be Data Storage 232 as depicted in FIG. 2. In this manner, a remote session established by a user may support one or more VMs 330 and therein a guess OS 355 and one or more Guest Applications 352A to 352N as depicted in FIG. 3B.

FIG. 3B depicts a high-level diagram of a computer system (host system) 300B supporting exemplary VMX environments supporting one or more aspects and/or embodiments of the present disclosure. Whilst FIG. 3B depicts a VMM based embodiment of the invention it would be evident to one of skill in the art that embodiments of the invention are also compatible with so-called thin hypervisors (see for example U.S. Pat. No. 10,204,220 entitled “Thin Hypervisor for Native Execution of Unsafe Code”). Accordingly, as a VMM works in a context of a VM controller user space then an Apple Hypervisor framework implements the thin hypervisor concept and is primary way to use Intel and ARM hardware-assisted virtualization capabilities upon the different MacOS releases.

The Host System 300B, e.g. Computer System 320 in FIG. 3A or Remote Access System 230 in FIG. 2, may include one or more central processing units (CPU) 380A communicatively coupled to one or more memory devices 380B and one or more peripheral devices 380C via a system bus, not depicted for clarity. The Host System 300B may implement a virtual execution environment for executing the software developed for a platform that is different from the native platform of the Host System 300B. In certain implementations, the virtual execution environment may be implemented using certain hardware-assisted virtualization features of the CPU 180A, which may support executing, at an elevated privilege level one or more elements, including but not limited to, a VMM 370 that manages one or more VMs. In various implementations, the VMM 370 may be implemented as a kernel module, a kernel extension, a driver, or a part of the Host Operating System (OS) 340. The Host OS 340 may further include a virtual interface component 142 which virtualizes a virtual interface component 142 to manage one or more Virtual Interface Devices 344 for use by the VM 350 and/or Host OS 340.

The VMM 370 may present a VM 350 with an abstraction of one or more virtual processors, while retaining selective control of processor resources, physical memory, interrupt management, and input/output (I/O). The VMM 370 may also present a VM 350 with an abstraction of one or more Virtual Interface Devices 344 of the Virtual Interface Component 342. A VM 350 may implement a software environment which may be represented by a stack including a Guest OS 355 and one or more applications 155A-155N. Each VM 350 may operate independently of other VMs and use the VMM-facilitated interface to the processors, memory, storage, graphics, and I/O provided by the Host System 300B. The VMM 370 may include a Virtual Interface Manager 372 to receive instructions to create a communication channel between a Host OS 340 and a Guest OS 355. The Virtual Interface Manager 372 may also send a request to Host OS 340 to create a Virtual Interface Device 344 and provide the Virtual Interface Device 144 to Guest OS 355. In considering VMX operation then there are two kinds of VMX operation commonly referred to, namely VMX root operation and VMX non-root operation. In general, a VMM, such as VMM 370 in FIG. 3B, will run in VMX root operation and guest software, such as Guest OS 355 and Applications 352A to 352N will run in VMX non-root operation. Transitions between VMX root operation and VMX non-root operation are called VMX transitions. There are two kinds of VMX transitions, those into VMX non-root operation from VMX operation are called VM entries whilst those from VMX non-root operation to VMX root operation are called VM exits.

Accordingly, a user may, for example, remotely access from either their PED, e.g. Mobile Device 210 in FIG. 2, and/or FED, e.g. Client Device 220 in FIG. 2, applications upon a remote system, e.g. Remote Access System 230 in FIG. 2, wherein a remote session they establish instantiates one or more instances of a Virtual Machine, such as Virtual Machine (VM) 350 in FIG. 3, to execute the application(s) the user wishes to execute. By virtue of exploiting VMs 350 then the operating system for these applications may be different from or the same as that of the operating system of the user's electronic device. Accordingly, the VM 350 operating system, Guest OS 355, for each VM 350 instantiated may be established as one of Linux, Windows, Android, and iOS, for example, which may be the same as or different to the operating system of the user's device, e.g. Mobile Device 210 or Client Device 220.

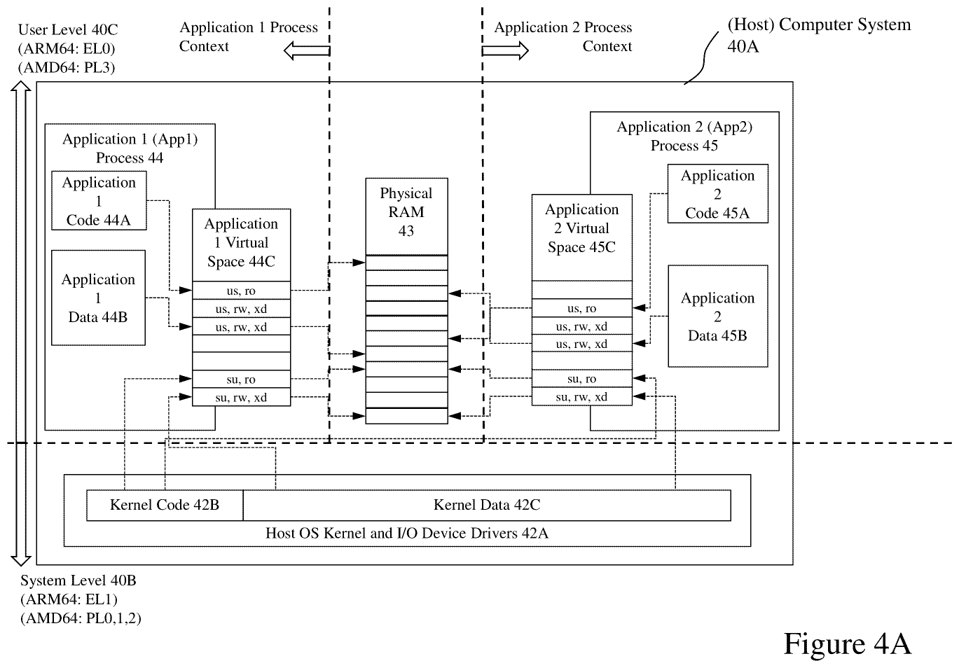

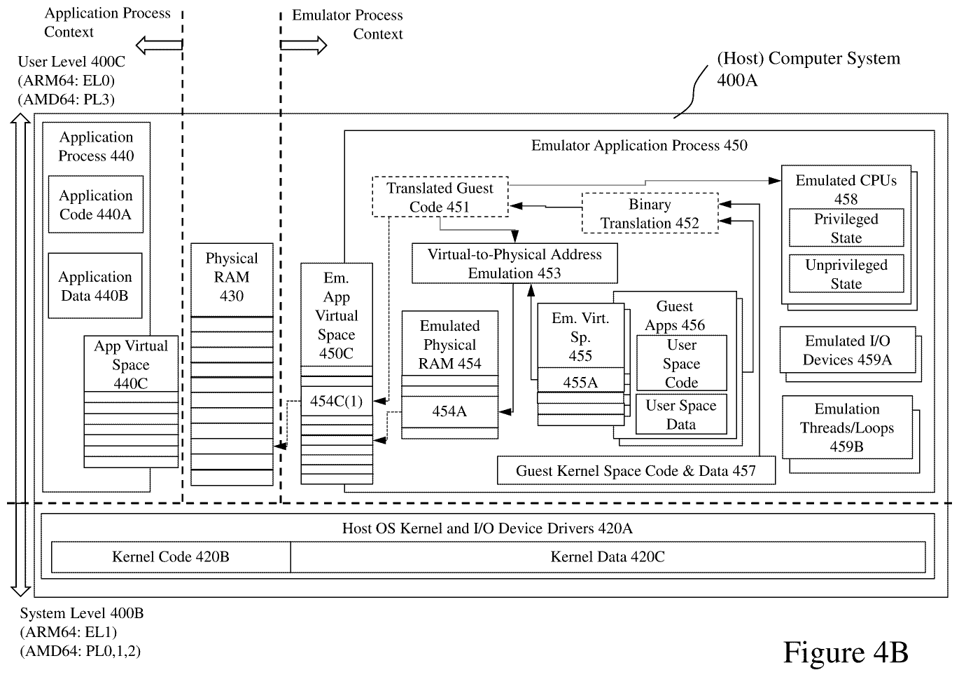

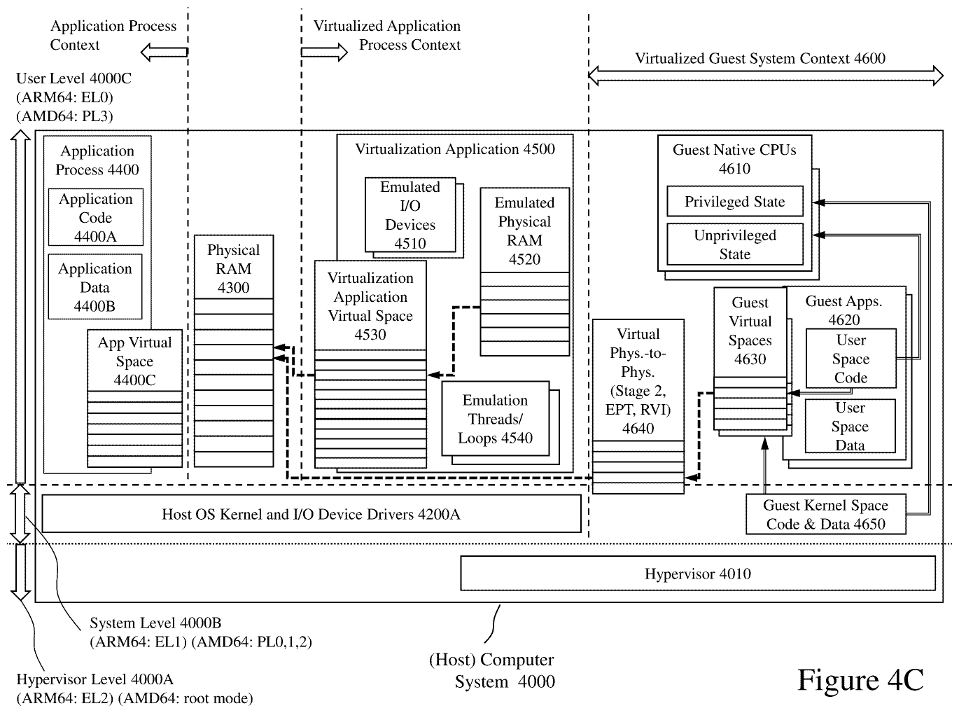

Embodiments of the invention relate to virtualizing a guest operating system (OS) inside a separate context, this separated context being separate to the host OS. Accordingly, the guest OS may be, for example, Microsoft™ Windows, Linux, or Apple™ Mac OS running application such as Microsoft™ Office (desktop productivity tools), Safari (a web browser from Apple™), or any other kind of applications side by side with the virtualization environment of the guest OS whilst a system upon which the virtualized environment runs is a host OS, such as Microsoft™ Windows, Linux, or Apple™ Mac OS for example. As depicted within FIG. 4A this is achieved within some prior art solutions by exploiting virtualized environments where each software application is virtualized into a separate other space from each other application. Within FIG. 4A the virtual space for a first application (Application 1) is depicted schematically to the left of the Physical random access memory (RAM) and the virtual space for a second application (Application 2) is depicted schematically to the right of the physical RAM. Each application comprising executable code (application code) and data (application data) which are mapped to a virtual space for that application. Each application's virtual space comprising this application code and application data at the user level together with kernel data and kernel code at the system level. Each application's virtual space pages (4 KB, 64 KB, 1 MB, 2 MB, 1 GB, . . . aligned virtual space regions) being mapped to the physical RAM pages so that it can be accessed when required. Accordingly, each application is associated with a virtual memory extension which are also known paging, paging tables, virtual spaces.

Application 1 Virtual Space 44C and Application 2 Virtual Space 45C depicted in FIG. 4A schematically reflects independent virtual linear address spaces of byte addresses from 0x0 to 0xFFFF . . . F corresponding to maximum length of addressable memory by CPU instructions. Not depicted in FIG. 4A within the virtual address spaces are their organization within 2, 3, 4 or 5-level hierarchies of the hardware page tables residing on the each logical unit (processor, core or processor hyperthread) of the central processing unit (CPU) which are employed such that each virtual space's page are mapped such that they can be accessed, ideally seamlessly, to execute the application code or process application data within the instruction pipeline when the logical CPU context is executing that application. Each page of virtual address space is mapped either to a physical RAM page with restrictions (like available for user or/and system modes, writes allowed/disallowed, code execution allowed/disallowed and other) or not mapped to physical page (non-present page). Operating system associates own set of page tables with each application to organize independent virtual address spaces. Thus, logical CPU switching execution from application 1 to application changes paging root pointer (e.g. stored in CR3 register in Intel and AMD architectures) from the highest page table of Application 1 Virtual Space 44C to the highest Application 2 Virtual Space 45C. Accordingly, the CPU when switching between applications must ensure that the virtual space of the application being switched away from is updated and then it must access the virtual space of the application being switched to.

Accordingly, this joint physical memory, physical RAM for example, which contains the code/data and to which the virtual spaces are mapped is divided into pages. The RAM may be divided, for example, into 4 kilobyte pages, 1 megabyte pages, 64 kilobyte pages, 2 megabyte pages, 1 gigabyte pages etc. The size of a page may be established in dependence upon one or more descriptors in the page tables of each virtualization context. Whilst a page size may be the same for each virtualization context (virtual space) associated with a CPU the page size my vary with the virtual space and thereby by the application associated with that virtual space.

FIG. 4A depicts a Computer System (Host) 40A comprising a System Level 40B and User Level 40C. Within the System Level 40B there are the Host OS Kernel and I/O Device Drivers 42A together with the Kernel Code 42B and Kernel Data 42C. Within the User Level 40C the Physical RAM 43 is depicted together with the processes for Application 1 44 and Application 2 45. Application 1 44 comprising Application 1 Code 44A and Application 1 Data 44B which are mapped to Application 1 Virtual Space 44C and therein to the Physical RAM 43. Similarly, Application 2 45 comprises Application 2 Code 45A and Application 2 Data 45B which are mapped to Application 2 Virtual Space 45C and therein to the Physical RAM 43.

As noted above the virtual space maps application code and application data at a user level to the RAM as well as kernel code and kernel data at the system level to the RAM. Typically, a CPU provides at least two functions within what is referred to as a privileged mode. One is the system function, so-called system level, whilst the other is user function, the user level. The system level relates to executing kernel code, device drivers and other “privileged” elements which are implemented by a particular operating system, e.g. host OS. As will become evident from the following description embodiments of the invention cover any types of processors that support at least these two types of CPU privilege level separation, namely at least a system level and user level.

For example, considering an ARM™ reduced instruction set computer (RISC) processor has what are referred to as exception level where EL0 is the less privileged user level and EL1 is the more privileged is system level where kernel code is run. Upon an AMD™ 64-bit microprocessor the user level is referred to as PL3 whilst the system level has one or more levels of a series of levels referred to as PL0, PL1 and PL2 (typically PL0 is only used). Usually, these privileges are reflected within the context page tables, in all virtual spaces, and located on predefined address space reserved for kernel space. Usually these protection levels or privileges are defined within a second part of a virtual address space and page tables may have protection bits besides their reference virtual address.

During execution the CPU executes the code of the kernel or particular instructions for the current application where when executed the virtual addresses of the application virtual paging table(s)/virtual space are translated by CPU to physical addresses within the RAM. Accordingly, it is evident that each process has its own set of page tables organized by kernel of operating system. Accordingly, user space pages are marked by user space bit, but a particular virtual address, for example, a 4 kilobyte page may be available for user space and might be also for kernel space simultaneously (modern CPUs may protect user space code and data from kernel as well). This depends upon permission settings where these permission settings are stored within a privileged register of the CPU and/or by particular bits in a particular descriptor in page table for particular page or virtual address range. The most important ones being those defining for the user space a super user (or system) mode where one User/Supervisor (U/S bit) defines this for the user space and read-write (R/W) bit enables or disables write operations to the page(s). Execute disable is managed by a non-execution (NX or XD) bit which is responsible to protect data from execution by the CPU. The general page availability for any accesses is managed by presence P bit. Next level page table and physical page address is also part of page table descriptor bitfields. There are other protection bits in page table descriptor allowing additional page management, but they are not so important for the invention embodiment. All these protection bits are hardware bits in the paging tables stored by the hardware, i.e. the CPU paging tables.

Accordingly, a logical CPU executing an instruction accesses a correspondent virtual address and performs seamless checks of permissions and virtual to physical address translation. The CPU caches address translation in a so called CPU translation lookaside buffer (TLB) such that next address accesses will be processed with significantly faster performance without the need for addressing real page tables. Another aspect is that such TLB cache entries must be invalidated “manually” by the OS memory management unit (MMU) code when the address translation or its permissions are changed. If code running on logical CPU tries to access a virtual address protected from that particular access the code instruction execution is interrupted by raising the special hardware paging fault (for example upon Intel or AMD architectures) or a data fault (for example upon an ARM architecture) exception, wherein a kernel level handler receives control for further handling the situation.

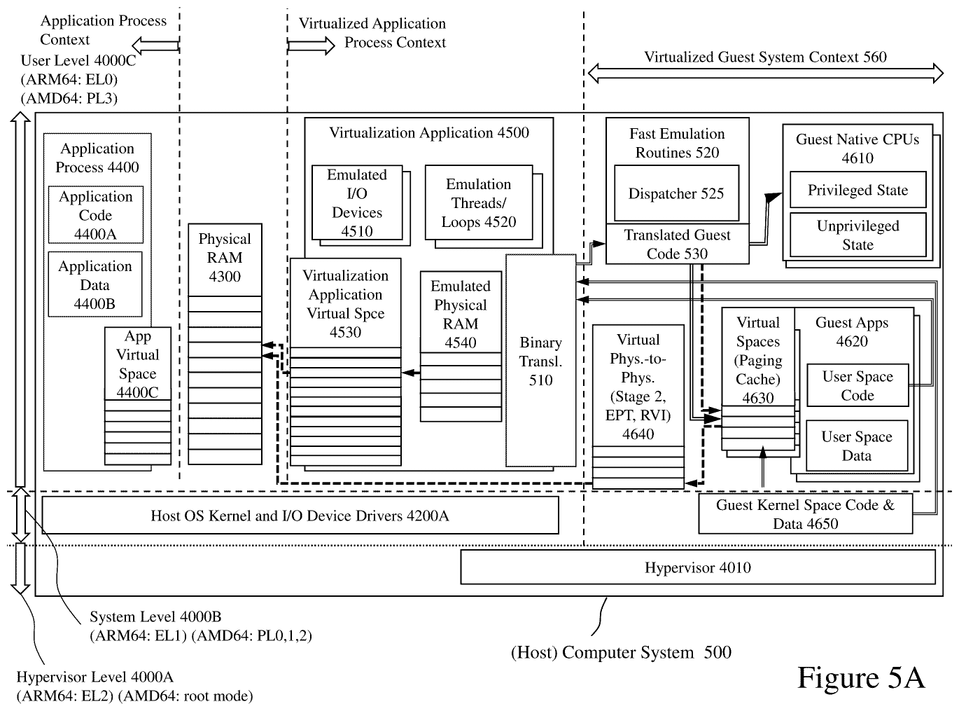

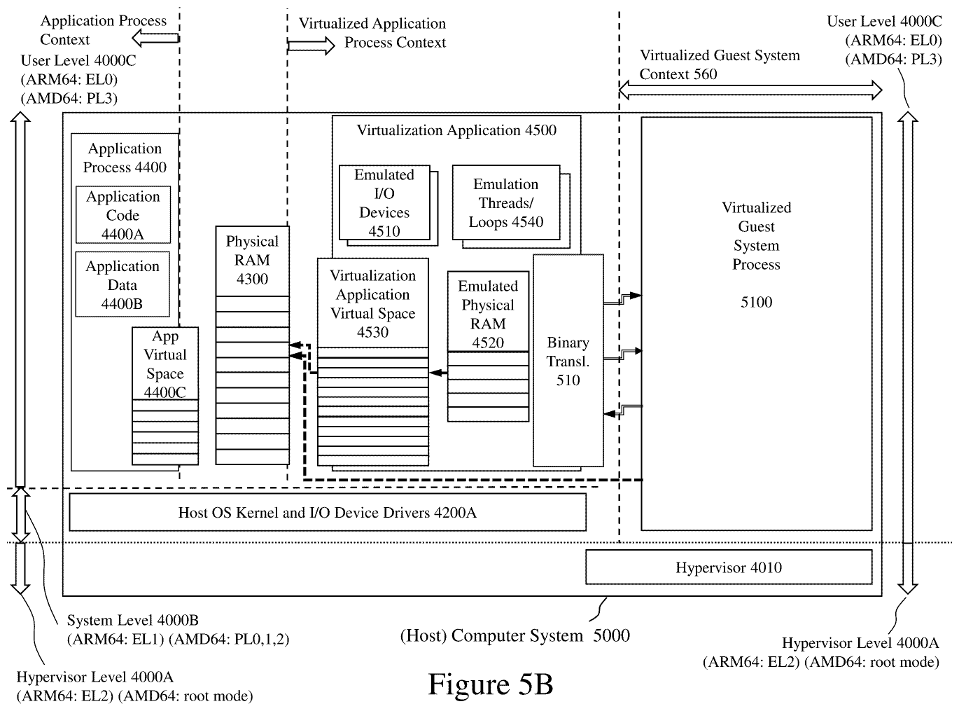

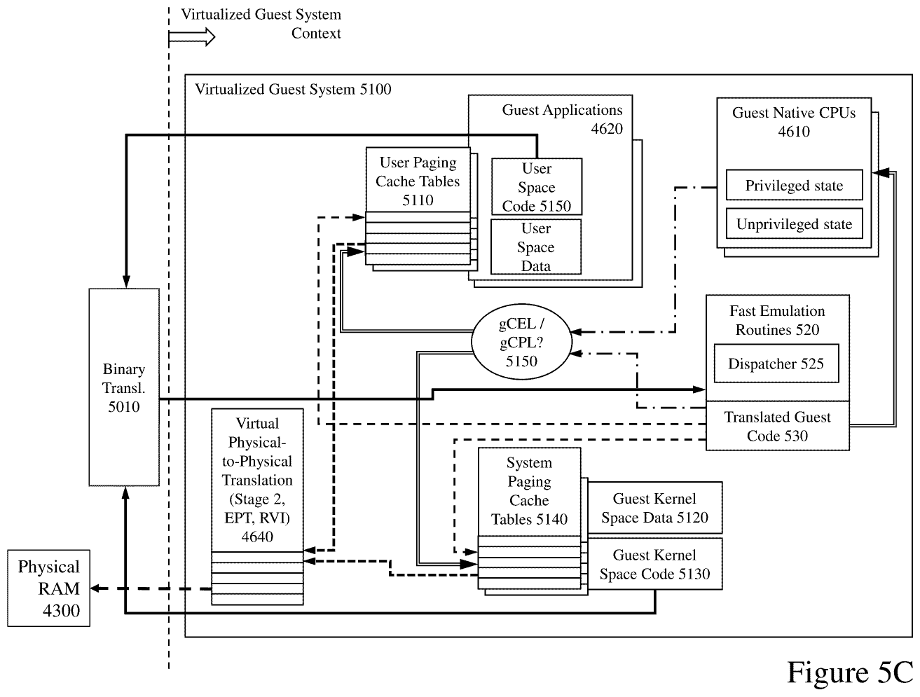

Within FIGS. 4A to 5C whilst specific visualizations are used to outline the systems and methods it would be evident that other numbers of applications can be supported by additional virtual spaces and virtual paging tables. Within FIGS. 4A to 5C dashed lines are intended to identify mapping(s) or make correspondence of mapping of particular buffer, code or data to corresponding virtual addresses, into corresponding structures.

Within virtualization environments where application code, the user level code, tries to access kernel data or kernel code then it gives rise to a hardware exception, which is handled by kernel code, and the system will try to recognize what kind of violation happened where if it was an inappropriate structure access it crashes the application. Accordingly, the kernel code running on the system level can handle hardware exceptions and is the only code which can decide what to do in an instance of a particular exception. As will become evident with respect to FIGS. 5A-5C and embodiments of the invention, this ability to handle exceptions is exploited within embodiments of the invention rather than crashing the application or OS kernel as occurs with the prior art. The host OS MMU subsystem uses a mechanism of page fault exceptions for physical memory allocation and reusage across multiple processes running in the system concurrently as well as for organization of page swapping to external storage, for example under low physical memory conditions. Embodiments of the invention exploit page fault exceptions to populate the paging cache with the guest virtual to guest physical addresses mappings, which are present in emulated page tables of emulated physical memory of emulated guest computer system.

With respect to the inventive concept the inventors also addressed emulation, particularly, platform emulation which is a well-known prior art technique depicted in FIG. 4B. FIG. 4B depicts schematically the emulation of guest operating system processes for virtual machines according to the prior art. Within platform emulation, such as that depicted in FIG. 4B, exploits provisioning of an emulator application process within the virtual space established within the user space which includes a virtualized CPU, an emulated CPU. Accordingly, the emulated virtual space means that when instruction gets CPU instruction access against virtual space, it has to reference the emulated virtual space and as a result an emulated physical RAM where this data or code is located.

Emulated virtual address space pages cannot be mapped to the same addresses within emulator application process context because the emulator code and data together with the host kernel code and data are already allocated to portions of the process virtual address space. The emulated guest system cannot access these pages natively by using emulated virtual address because they are already busy for storing the host code and data. Intermediate emulator structures are required to look up a real location of the destination emulated guest page to perform the emulated read or write operation. Therefore, within the emulated space we again encounter situations where the emulator is trying to simulate behavior of a guest operating system or even incompatible CPU behavior using the rules of the host operating system.

The emulated process will run its own code and emulation routines in context of an ordinary process which also has pre-allocated by the host operating system, where paging tables will also have a kernel path allocated and kernel range will typically be allocated at the end of virtual address space. Some emulators also allocate buffers which may be unpacked during the startup process. All of these form part of overall emulator memory which is located in the same virtual space. Therefore, this virtual address space, the hardware virtual address space, will take (reserve) virtual addresses which then cannot be used by the emulator to map guest virtual addresses to this context. Therefore, as a result, it is necessary for the guest code to be translated even when the architecture, the emulated architecture, corresponds to the physical one, i.e. to the host processor. Accordingly, even simulating ARM™ on ARM™ will require emulation of the ARM itself or simulating an AMD64 or Intel ×86 on Intel ×86 will require emulation of the Intel ×86 itself. However, the optimization can require the guest-to-host address translation mechanism to translate one kind of unsafe set of guest pages to a set of safe pages. It would be evident to one of skill in the art that the schematics within FIGS. 4A to 4C are representations. For example, with respect to FIG. 4B the complexity of the emulator is much more sophisticated and complicated than as depicted.

But anyway, in terms of, just in simplified terms, each emulator has to have so-called emulation loops, which represent parallel execution of particular guest CPU core. Each CPU core is usually executed in separate host OS thread, or so-called emulation loop. Within the emulator the emulated process employs an instruction pointer IP/EIP/RIP (for 6-bit, 32-bit and 64-bit processors respectively) as used by AMD64 or ×86 processors or program counter PC as used by ARM architecture. This points to the current executed instruction which, again, because of the guest virtual space location how the guest operating system, guest kernel code, guest data, see the virtual process address, guest virtual process address space. This can be controlled therefore it operates such that the same digits referenced by guest code instructions can be the same virtual address ranges that host OS process can use, especially at the intersection of guest code, guest kernel code, and host OS kernel code address spaces. Accordingly, the guest program counter has to be emulated. Because program counter and instruction pointer play the same role but for different processor architectures, therefore. further terms about program counter register will be imply the same terms about instruction pointer for Intel and AMD architectures and similar registers for positioning current executed instruction for other CPU architectures.

The guest program counter is taken by the emulator in an emulation thread or loop and one by one instruction assimilated behavior of guest CPU, taking one instruction by one instruction, is simulated one instruction by one instruction. However, this translation is not fast and optimization difficult thereby slowing the emulator. Usually, binary translation is used to simulate guest operating instruction behavior in context of host OS process. In such condition, just an unprivileged state can be used natively, binary translated code talking about same architecture, virtualization, if guest OS architecture corresponds to the host OS one, ARM on ARM, for example then we can use, for example, general purpose registers with exact correspondence to host platform besides registers used for virtualization purpose. For example, to reference emulator structures from binary translated code therefore, for example, the R0 register of guest operating system, of guest code, will correspond to R0 register of host CPU. In this case, using binary translation, we can achieve using almost all unprivileged guest CPU state native execution. Accordingly, the inventors as outlined below exploit this major advantage of binary translation. If the guest CPU architecture differs from the host CPU (e.g. ×86 simulated on ARM) then binary translation generates blocks of target CPU's instructions (ARM) simulating behavior of translated source code blocks (×86). In this case state of source CPU should be mapped to a target unprivileged state (e.g. ×86's RAX can be mapped to ARM's R0) or be emulated.

A further advantage of leveraging binary translation is that we can optimize execution by packing the emulation with multiple host CPU instructions to execute the minimum emulated code as much as possible where minimizing the pattern of emulation allows us to exploit reproducing behavior of particular instructions working in popular conditions, unpopular cases can still be emulated in slower way. Binary translation generates blocks of translated code, usually are tied to guest virtual address space or in some embodiments of the invention, it can be tied to physical address space as we are talking about the exact location of data instructions within the virtual space and therein physical space. Whilst the guest kernel and user space code is not executed directly by the host processor, it is data, which can be stored but the host CPU program counter will not start to point to a particular address. This guest code and data are stored in a corresponding physical memory of the guest and host operating system. To represent guest physical memory, usually parts of real memory are located in a memory heap or in memory mapped files as a whole long buffer which is located by using a host OS application programming interface (API) within the space of the emulator process. Accordingly, getting a guest OS physical address, guest OS physical address referenced by instruction through a virtualized guest virtual address space can be achieved by a search, and can be easily allocated in a real buffer which is allocated by the emulator using the host OS operating system.

Within the emulator application process there is emulated physical RAM, which is a buffer allocated in context of emulator process as a standard buffer and as such can be implemented in more complicated manners than a single buffer such as divided to blocks, building some logical chain with some cache, etc., in order to utilize more effectively a virtual address space. Typically the guest OS runs in protected mode with enabled paging address translation, thus usually the emulated physical RAM is not directly employed by the guest OS, rather it is used after a virtual to physical address translation, i.e. after translation by using the guest paging tables, which consists of dozens instructions of emulator routine and brings a significant degradation in performance of every emulated memory access instruction of this binary translation code. This arises as the required data is not accessible rapidly. Memory organization is generally established such that the most often accessed data is located in general purpose registers, and we see at times that unprivileged states can be executed almost natively by translated code. However, the processor general purpose register set is strictly limited (e.g. to 16 registers for the Intel ×86 64-bit architecture and 31 registers for the AMD64 architecture) and program code must use memory to store data. Typically, every 7^{th} to 10^{th} instruction accesses memory by using guest virtual address which results in a large number of accesses. Whilst those made to general purpose registers are quite fast in access to data within internal processor storage and virtual memory is slower than accessing general purpose registers and accordingly this degrades performance even on an ordinary physical CPU yet alone an emulated CPU.

Memory virtualization is quite important, sometimes even more important than accesses to a full set of an unprivileged state. In case of emulator or even binary translation, we need to parse and organize the virtual Translation Lookaside Buffer (VTLB), which caches mappings from virtual to physical addresses, which like other virtualization solutions holds this the guest virtual address to host or to guest physical address translation. Within embodiments of the invention this translation may be hardware-assisted caching, which the inventors refer to as Paging Cache. The Paging Cache stores the real paging structures and is specifically organized with respect to mapping guest virtual addresses to the real paging structures and regarding guest condition when this translation operates with respect to the guest mode.

This impacts performance as, for example, even trying to cache translation of guest virtual addresses to emulated physical addresses and pointing to particular real buffers representing physical page of a particular address, represents a large number of instructions where each instruction which should check its permissions. For example, is the code eligible to access a particular virtual address? Are there some protection restrictions to access, for example, guest user code instructions to a particular virtual address? Is it trying to access guest kernel code, which is protected by using user-supervisor bit, etc. All these protections, all protection checks should be performed on the emulator code, even if it is aligned with the binary translated code. As such this significant number of instructions and their associated permission checks represent a significant aspect of the degradation of the emulator and even the binary translation process in terms of simulation.

FIG. 4B depicts a Computer System (Host) 400A comprising a System Level 400B and User Level 400C. Within the System Level 400B there are the Host OS Kernel and I/O Device Drivers 420A together with the Kernel Code 420B and Kernel Data 420C. Within the User Level the Physical RAM 430 is depicted together with the processes for Application Process 440 and Emulator Application Process 450. The Application Process 440 comprising Application Code 440A and Application Data 440B which are mapped to Application Virtual Space 440C and therein to the Physical RAM 430. The Emulator Application Process 450 similarly comprises an Emulator Virtual Space 450C to which are mapped Emulated Physical RAM 4540 and Translated Guest Code 451. The Translated Guest Code 451 is coupled to the Emulated CPUs 458 and Virtual-to-Physical Emulation 453 wherein the Virtual-to-Physical Emulation 453 is coupled to the Emulated Physical RAM 454. Translated Guest Code 451 receiving from the Binary Translation 452 which receives from the Guest Kernel Space Code and Data 457 and the Guest Applications (Apps.) 456. The Guest Applications 456 comprising user space code and user space data. The Emulated CPUs 458 comprises privileged and unprivileged states. The Emulator Application Process 450 also comprising Emulated Input/Output (I/O) Devices 459A and Emulation Threads/Loops 459B.

As evident from FIG. 4B it is evident that the Emulator Application Process 450 has multiple dependencies with respect to emulated virtual-to-physical address translation. As depicted these include a link from the Emulated Page Virtual Address 455A to the Virtual-to-Physical Address Emulation routine 453, therein to Emulated Physical Page Address 454A within Emulated Physical RAM 454, therein to Emulated System 4 KB Buffer Virtual Address 454C(1) within Emulated Application Virtual Space 450C and therein the actual mapping to the Physical RAM 430.

Now referring to FIG. 4C there is depicted schematically hardware assisted virtualization of guest operating system processes for virtual machines according to the prior art. This approach being commonly referred to as exploiting a hypervisor. Whilst there are differences between different vendor implementations of the hypervisor, for example Microsoft™ Hyper-V, Parallels™ Hypervisor, or VMware™ Hypervisor, the operating principles are basically the same as those of the Parallels™ Hypervisor. The hypervisor provides for extended levels which are implemented by the processor, i.e. hardware virtualization. Hardware virtualization in different architectures, different CPU architectures, it is implemented in different ways. For example, with respect to ×86 or AMD 64 then it is implemented as separation of the same set of privilege levels, i.e. privilege levels 0, 1, 2, and 3 in terms of Intel™ (VT-x) or AMD™ (AMD-V) platforms. This separates the guest environment from the host environment and the guest environment is executed under special structures control, so-called virtual machine control structures (VMCS) or virtual machine control blocks (VMCB), which provide a so-called deprivileged non-root environment. A special software Hypervisor running in so-called root mode is responsible for allocation and organization VMCSs/VMCBs and virtualized non-root context itself to run non-modified guest code in hardware-assisted isolated context having the same set of privileged levels 0-3. The VMCSs/VMCBs declare conditions which have to raise so-called VM Exit events in cases when a guest code instruction or state can be executed natively. These VM Exits are handled by Hypervisor handlers referenced in particular sections of the VMCSs/VMCBs and re-call in one embodiment the VMM (if the virtualization software separates emulation from Hypervisor) or emulate by itself (if system emulator is a part of monolithic Hypervisor such as Kernel-based Virtual Machine for Linux for example). Essentially non-root context is the same set of privileged levels but under additional control of virtual machine control structures. In this manner the host may be executed as a guest inside a same non-root mode or it can reside within the hypervisor executed in so-called root mode, or even in normal non-hardware-assisted privileged mode outside root-mode if Hypervisor disables hardware virtualization capabilities each time the processor is switched back to host OS context.

The root mode of ×86 and AMD64 architectures implements the same set of privilege levels as a non-root mode but without restrictions. The non-root mode restrictions are described by the VMCS or VMCB. The hypervisor control all switches between the guest operating system context, namely the guest operating system set of privileged level modes, native privileged level modes, and the host OS set of privilege level modes which are executed without restriction. By handling a so-called VM Exit, which is triggered by a protection violation or by some protection setting which can be independent of whether the VM is executing kernel code, guest code, kernel code, or user space code. Upon a VM Exit the process switches from the non-root modes to a root mode of the hypervisor handler which decides what kind of violation occurred, what should it do, and whether it should simulate something. For example, if the guest operating system tries to access memory, then as modern devices are memory mapped, the guest platform device has to have a particular guest physical memory range associated with emulated device that guest kernel driver instructions can communicate with emulated device in order to perform an action, such as play sound, send network packets, write and read data to emulated hard drive, etc. Accordingly, the emulated memory is protected by permission bits within the page tables and cache tables such as when considering the binary translation presented in respect of FIG. 4B.

With respect to FIG. 4C then the emulated memory is referenced from the Emulator is accessed natively through hardware-assisted virtual-to-physical translation including ordinary guest page tables used without any modifications and EPT/RVI stage 2 translation page tables. Regarding a role of guest physical page (e.g. ordinary guest physical RAM page or guest I/O device mapped page) it is left available for all guest accesses or can be protected by permission bits in 2^{nd} stage translation page tables implemented by Extended Page Tables (EPT) as titled by Intel™ or by Rapid Virtualization Indexing (RVI, also known as Nested Page Tables (NPT)) by AMD™, or by stage 2 translation extension by ARM. In either instance these are a special additional layer of another kind of paging tables that translate guest physical addresses to host physical addresses, to physical addresses, natively by CPU. These are hardware structures controlled by the hypervisor, converting guest physical addresses and mapping them to host physical addresses. If the hypervisor is implemented upon an ARM™ processor then there are similar structures, referred to as stage two which provides the paging address translation. Stage one upon ARM™ is ordinary virtual addresses to guest virtual addresses to guest physical address translation and ordinary native guest page tables are used to translate guest virtual addresses to guest physical ones, but guest physical ones should be additionally translated to real physical addresses by using hardware structures. These paging tables, be they EPT, RVI, or Stage 2 tables, make it possible to run all code, all guest code, run natively within this deprivileged non-root environment.

Within FIG. 4C at least the hypervisor level for an AMD64 and Intel ×86_64-bit implementation are identified as root mode, thus Hypervisor usually runs in root-mode PL0. Hypervisor can implement switching off mechanism when it returns control to host OS. Host OS system level and user level, Protection Level (PL) 0 (or 1,2), and PL 3 respectively will run when all virtualization means are disabled (no root- and non-root-modes are active) till the next CPU control transition to Hypervisor, which context switch will enable VT-x/AMD-v again for next time quantum used for guest OS execution. Alternatively if the Hypervisor does not disable hardware virtualization in Hypervisor-to-host switches, the host OS kernel and user contexts will continue running in respective root mode PL0 and PL3. Hypervisors like Xen and Hyper-V put host OS to so called service VM context and run host OS kernel and user contexts in non-root PL0 and PL3. With an ARM implementation then ARM hardware virtualization has a different implementation, perhaps viewed as simpler than that of AMD64, where the hypervisor level, system level and user level are denoted by Exception Level (EL) which are EL2, EL1 and EL0 respectively. Hypervisor resides on EL2 while host OS is running in own isolated EL1 and EL0 as well as guest OS contexts in separated isolated sets of EL1s and EL0s. It should be noted that ARM does include a fourth level, entitled L3 and also known as the secure level, but this is primarily for firmware, booting and secure booting, secure platform initialization etc. This is not depicted as it is immaterial to the hardware assisted visualization of the prior art hypervisor solution and is not employed within embodiments of the invention described and depicted in respect of FIGS. 5A to 5C respectively.

Accordingly, a difference of ARM's implementation of the hypervisor level and control execution of host operating system is similar to that of guest environment one. Namely, the hypervisor seeks to exploit as far are possible the host OS which has less restrictions and reduce the number of switches to the hypervisor level as these require many restrictions to be controlled by the hypervisor, which need to be simulated by the virtualizer on the system.

Accordingly, in the case of hardware virtualization, the guest system runs natively within an unprivileged state of the CPU or in a privileged state. For example, a paging root pointer stored in privileged control register CR3 in Intel and AMD architecture points to the real physical memory region, the physical 4K page of the RAM, where particular paging tables describing virtual space of the particular guest OS process are located. Similarly, a privileged translation table base registers TTBR0 and TTBR1 contain the paging root pointers in the case of an ARM architecture where these point to the highest level of this paging structures (for virtual addresses patterns 0x00 . . . 00XX . . . XX and 0xFF . . . FFXX . . . XX accordingly), namely the native paging structures. In the case of Intel or AMD architectures, this is referred to as the CR3 register, which points to the topmost page table, which is initial point to start virtual address to physical one translation through the page tables, which are typically organized in a hierarchy structure, and further typically consist of two, three to four levels. Virtual address referenced by memory access instructions is divided by the hardware CPU into parts where the topmost significant bits will be used to index descriptors in top-most table (tables) whilst lower bits are employed to index descriptors within lower-level tables. For example, considering an Intel/AMD 64 bit execution mode this uses 64 bit virtual addresses. The paging table hierarchy has 4 levels indexed by 9-bits taken from correspondent part of the virtual address. The lowest 12-bit virtual address part references the offset within the 4 KB physical page. The next 4×9=36 bits of the virtual address stores indices in 4 levels of paging tables. Practically just 48 bits of the virtual address are significant and the topmost remainder of the bits duplicate bit 47's value. This is known as a canonical address within Intel and ARM architectures.

Finally, the translation process goes through this paging structure so that we have guest virtual address association with host physical one (in case of disabled Intel EPT, AMD RVI and ARM second stage translation feature) or with guest physical one (if EPT, RVI or SLAT is enabled). In terms of second stage translation, it will be associated with guest physical address, which will be additionally translated in the similar way, but by using another set of (EPT, RVI or SLAT) page tables to real physical address such that all construction (virtual to guest physical and guest physical to host physical address translation) will work natively on real CPU.

FIG. 4C depicts a Computer System (Host) 4000 comprising a Hypervisor Level 4000A (root-mode PL0 in Intel/AMD architecture, EL2 in ARM architecture), System Level 4000B and User Level 4000C. Within the Hypervisor Level 4000A is the Hypervisor 4010. Within the System Level 4000B there are Host OS Kernel and I/O Device Drivers 4200A. Within the User Level 4000C to the left are the Application Process Context which executes the ordinary host OS Application Process 4400, the Physical RAM 4300 and Virtualization Application 4500. The Application Process 4400 as depicted in FIG. 4C on the left hand side comprises Application Code 4400A and Application Data 4400B which are mapped to Application Virtual Space 4400C and therein to the Physical RAM 4300.

The Virtualization Application 4500 comprises Emulated I/O Devices 4510, Emulated Physical RAM 4520 (which is mapped to the Physical RAM 4300) via the Virtualization Application Virtual Space 4530, and the Emulation Threads/Loops 4540. The Application Process 4400, the Physical RAM 4300 and Virtualization Application 4500 within the User Level 4000C above the Host OS Kernel and I/O Device Drivers 4200A within the System Level 4000B.

The User Level 4000C and System Level 4000B as depicted in FIG. 4C on the right hand side further comprises Virtualized Guest System Context 4600 above the Guest Kernel Space Code and Data 4650 above the Hypervisor 4010 within the Hypervisor Level 4000A. The Virtualized Guest System Context 4600 comprising Guest Native CPUs 4610, Guest Applications 4620 and Guest Virtual Spaces 4630 which are mapped to Virtual Physical-to-Physical Translation 4640 which is mapped to the Physical RAM 4300. The Guest Native CPUs 4610 comprises privileged and unprivileged states that are coupled to the Guest Applications 4620 and Guest Kernel Space Code and Data 4650. The Guest Kernel Space Code and Data 4650 is also coupled to the Guest Virtual Spaces 4630.

Referring to FIGS. 5A to 5C there are depicted schematics of architectures for virtualization environments according to embodiments of the invention. Whilst these identify the user, system and hypervisor levels with reference to ARM exception levels or AMD protection levels the underlying concepts can be applied to other processor such as Intel™ ×86 for example.

As will become evident the embodiments of the invention described with respect to FIGS. 5A to 5C exploit hardware assisted binary translation which is beneficial in translating between different kinds of architecture instruction such as when the guest OS architecture differs from host OS one, for example, ×86 on ARM, AMD64 on ARM, ARM on AMD64 and ARM on ×86. However, it will become evident that the embodiments of the invention can also beneficially support the same kinds of architecture instruction such as when the guest OS architecture is the same as the host OS one, for example, ×86 on ×86, ARM on ARM and AMD64 on AMD64.

The embodiments of the invention build upon the prior art depicted in FIGS. 4A to 4C through a non-obvious combination of these with additional elements and functions to achieve a sophisticated and non-trivial leveraging of the prior art. Amongst these are a number of modifications to enable access to guest OS memory native for incompatible CPU instruction architectures.

Considering the guest CPU, although the architecture of the CPU is different, by organizing the virtualized guest system context within a separate hypervisor control context we can achieve the situation where the virtual address space is under control of supervising code with the highest privilege and can control, but not break host OS operating system, by handling the restrictions of this context. To the inventors knowledge this methodology is unique and novel. Accordingly, in the case of an unprivileged state, despite the set of registers, the general purpose registers, being different for two architectures, then using binary translation we can map native, general, guest general purpose registers to host OS ones. Accordingly, for example the RAX register of an emulated ×86 platform is mapped to R0 of an ARM processor to support ×86 upon ARM. The embodiments of the invention can handle different simulated conditions even those outside of the normal context(s) as the inventor virtualization application according to embodiments of the invention as a reserve simulator of the platform. Accordingly, if we are unable to execute something natively, then we will switch through the hypervisor to virtualize the application environment in order to simulate the behavior of guest operating system within this simulator. However, it would be beneficial to execute as much as possible within the virtualized context and seek to support common emulation cases in this context rather than passing execution to an emulator which is instruction heavy.

Continuing with the ×86 on ARM example then we make the association that the RAX register is stored within the R0 register of the ARM processor and therefore it will be allocated just for this and during even exceptions and exits to the instruction heavy virtualizer, the process still knows that the ARM R0 register, the native R0 register, contains a guest RAX register. Accordingly, an unprivileged state can be fully executed natively, be fully simulated, if enough registers exist for the host OS to map all those of the guest OS. For a privileged state this contains a number of specific registers, processors, etc. but again this can be handled by mapping registers etc. For example, consider handling the paging root register, which happens each time the guest operating system switches CPU allocation from one guest process to another guest process. Accordingly, this requires switching of the paging root register from one paging structure for the current process to another paging structure representing the other process within the guest operating system.

As evident in FIG. 5A the guest application code is passed from the virtualized guest system context to the binary translation within the virtualizer application process wherein the translated guest code is then passed back to the virtualizer guest system content and therein to the guest CPU within the virtualizer guest system context. Whilst the binary translation is depicted within the virtualizer application, which is within the user level it may be located within a privileged space which may improve performance. Where the binary translation is performed in the unprivileged space then as it provides translation of guest operating code instructions to host operating instructions it can keep the translated (and subsequently) executed code in a cache for faster processing.

As the hardware assisted binary translation is mostly a translation operation of guest OS code instructions to host OS code instructions, mostly of which are not one time translations, employing the cache is beneficial. Whilst the cache storing the translated code will reset from time to time this is a relatively rare operation in comparison to accessing the CPU state or memory state. Accordingly, the approach keeps binary translation routines on the host side for convenience, because, for example, the host OS side has libraries, frameworks, etc., which the binary translation module/code can use for allocation memory, buffers, etc. in comparison with deprivileged contexts where no API even resides, just the guest OS one. There is no host OS in this context and no function of host OS here. In order to call any functions of the host OS, we need to switch context through the hypervisor to the system level user space. Whilst the binary translation can be moved here, it will require additional effort to support everything supported by the host API in this context.

Now referring to the translated guest code and fast emulation routines within the virtualized guest system content. The fast emulation routines are translated code, blocks of translated sequential guest instructions to host ones where this set of translated instructions can be executed natively, repeating the behavior of guest code in terms of emulated structures. This may, for example, be a subroutine which is repeated such that the fast emulation code is the sequence of simulated, translated instructions for this subroutine. Alternatively, it can be a function which is repeated in different instructions. Accordingly, this can be moved as translated code into the fast emulation routines. Fast emulation routines therefore are functions implemented and predefined by our virtualizer and by binary translation routine which reside side-by-side with translated code where the translated code can make a call to or jump to a fast emulation routine to do some function, to repeat a function which is necessary in many instructions.

In this case, the translated guest code organizing this context, separated context, can exploit the benefits of second state guest physical addresses to host physical addresses, hardware structures, and hardware capabilities of CPU, on-host CPU. Therefore, besides the range of virtual address space for the kernel, some additional virtual space is reserved which is not accessed by guest OS code or rarely accessed by guest OS code, guest kernel code, user space guest code. This virtual address space is employed to store the translated guest code and fast emulation routines. Within embodiments of the invention this virtual address space is protected. Typically, this range of virtual address space is the only part not owned by the guest operating system whilst other address space ranges before and after this reserved range can be used by guest operating system code natively in terms of its virtual address space instructions. The virtual address space does not have to be translated to some other addresses, to some buffer reference, etc. as it is just an address which can be used natively without any kind of translation which provides a benefit to embodiments of the invention. This is an important element of embodiments of the invention in that it allows us to use hardware structures, organizing these paging structures natively and can use both levels of translation, stage one and stage two, to get native mapping of guest virtual address to host physical RAM page.

However, it would be evident that the system should also handle these page tables both due to the incompatible architecture, namely the guest operating system, but also because the guest CPU has different descriptors, different page tables, which are incompatible with the host architecture. Accordingly, to provide this the inventors organize a shadow copy of these page tables, which correspond to real paging structures of the host architecture, using a method known in the art, such as, for example that described and presented within U.S. Pat. No. 7,596,677 entitled “Paging Cache Optimization for Virtual Machine”, the entire contents of which are incorporated herein by reference. Within embodiments of the invention the creation and organization of these shadow page table can be performed upon the establishment of the virtualization environment of the guest OS or first accessing of the guest OS code.

Within an embodiment of the invention initially all virtual address space of the system is protected so that it maps nothing except system translated code region. When the first instruction gets translated, the guest code access the memory giving rise to a page fault. As within embodiments of the invention the fast emulation routines also includes a page handler, a page fault handler, like the operating system kernel has then the fast emulation routine will detect that it is not used currently nor was it before and thereby create the necessary mapping, namely organize page tables entries regarding guest mappings, and restart this particular instruction, i.e. interrupt guest code instruction and execute natively. The next time access to a particular guest virtual space occurs then the exception will not happen, the page fault will not happen, it runs natively. Accordingly, within the embodiment of the invention depicted in FIG. 5A the system level and user level are running natively.

As evident from FIG. 5A the virtualized guest system context is executed in two CPU modes, namely the system level and user level. Accordingly, within embodiments of the invention a single set of paging and cache tables can represent both layers. Accordingly, the inventors exploit a user-superuser bit(s) within the Paging Descriptor of the paging tables to make a particular virtual address available/accessible for system level code, the guest system level code, or for user level code, or in some instances both simultaneously. Accordingly, embodiments of the invention can use these bits to simulate guest behavior in accessing this virtual address. However, this multi-level approach as it includes both physical CPU level system level and user level can mean that during emulation of a guest processor instruction, even in user level, we require to access the privileged state of the physical CPU. In order to manage this the inventors implement a dispatcher to handle access to or simulate access to the privileged state of the physical CPU.

Within some embodiments of the invention this micro-virtualization kernel may be included within the fast emulation routines. The micro-virtualization kernel manages page faults, namely hardware page faults, which arise from the protection of or non-existence of pages within the virtual context. Within FIG. 5A the micro-virtualization kernel is depicted within the fast emulation routines. As such the micro-virtualization kernel handles page faults or any kind of exception, during execution of instructions which are not allowed, for example, in user level, on user level. The micro-virtualization kernel resides within the virtualized guest system context and in a manner similar to the host OS kernel resides in privileged mode in each application process context. The micro virtualization kernel can handle the necessary exceptions to provide virtualization without exits to the host OS context.

Considering an ARM processor then switches between user level or system level, then to hypervisor level, and back to host OS system level or user level is relatively costly in CPU processing time taken to undertake the switch. However, it is even more expensive in respect of CPU processing time when considering Intel or AMD hardware utilization as switching contexts between, for example, non-root mode and root mode in Intel and AMD hardware virtualization can take approximately 700 clock ticks (ticks) of the processor, i.e. approximately 700 bus clocks of the processor. In comparison executing a single instruction with the CPU can take just one tick although within a speculative execution mode and parallel CPU conversion, one instruction can be executed even faster than one tick. But in switching between contexts, it is necessary to break all these CPU pipelines resulting in longer times such that it can easily reach 1,000 ticks to switch between contexts which is quite expensive from a performance point of view. Accordingly, implementing the micro-virtualization kernel allows, for example, maintaining the paging cache or some protection fault to be simulated easily without complex emulation in the context of the virtualized guest system. Implementing micro-virtualization kernel within the fast emulation routines therefore within the user level offers performance benefits which are increased further with a small micro-virtualization kernel.

One limitation of the multilayer implementation is that the user level does not have access to the physical CPU privilege state and therefore in some instances it will require to access, to call, the system level to do perform something privileged. However, this is still faster than exiting and switching to the host OS.

Now referring to FIG. 5A there is depicted a Computer System (Host) 500 which in common with Host Computer System 4000C in FIG. 4C comprises a Hypervisor Level 4000A, System Level 4000B and User Level 4000C. Within the Hypervisor Level 4000A is the Hypervisor 4010. Within the System Level 4000B there are Host OS Kernel and I/O Device Drivers 4200A. Within the User Level 4000C to the left are the Application Process Context which executes the Application Process 4400, the Physical RAM 4300 and Virtualization Application 4500 where the Application Process 4400 comprises Application Code 4400A and Application Data 4400B which are mapped to Application Virtual Space 4400C and therein to the Physical RAM 4300.

The Virtualization Application 4500 comprises Emulated I/O Devices 4510, Emulated Physical RAM 4520 (which is mapped to the Physical RAM 4300) via the Virtualization Application Virtual Space 4530, and the Emulation Threads/Loops 4540. The Application Process 4400, the Physical RAM 4300 and Virtualization Application 4500 within the User Level 4000C above the Host OS Kernel and I/O Device Drivers 4200A within the System Level 4000B. In contrast to Virtualization Application 4500 within Computer System 4000 in FIG. 4C the Virtualization Application 4500 within Computer System 500 in FIG. 5A also comprises Binary Translation 510 which is hardware assisted.

The User Level 4000C and System Level 4000B as depicted in FIG. 5A on the right hand side further comprises Virtualized Guest System Context 560 above the Guest Kernel Space Code and Data 4650 above the Hypervisor 4010 within the Hypervisor Level 4000A. The Virtualized Guest System Context 560 comprising Guest Native CPUs 4610, Guest Applications 4620 and Guest Virtual Spaces 4630 which are mapped to Virtual Physical-to-Physical Translation 4640 which is mapped to the Physical RAM 4300. The Guest Native CPUs 4610 comprises privileged and unprivileged states that are coupled to the Guest Applications 4620 and Guest Kernel Space Code and Data 4650. The Guest Kernel Space Code and Data 4650 is also coupled to the Guest Virtual Spaces 4630. The Guest Applications 4620 are coupled to the Binary Translation 510 and the output of the Binary Translation 510 is coupled to Fast Emulation Routines 520, which comprises at least Dispatcher 525, and Translated Guest Code 530 and therein the Guest Native CPUs 4610.

Now referring to FIGS. 5B and 5C the overall concept of this embodiment of the invention looks similar to the embodiment of the invention depicted in FIG. 5A but importantly all code resides on the system level as we translate all guest code instructions to the target architecture, i.e. to the target host CPU architecture. Therefore, we can control both guest levels, i.e. the system level and guest user level, and properly translate instruction regarding simulated exception level. Further, the embodiment of the invention allows for switching to occur as we have two copies of paging cache tables. One copy of the paging cache tables will map pages and have permission bits in the descriptors, paging cache descriptors, corresponding to proper access to proper protection of the page just as if it were to be accessed from guest user space. The other copy of the paging cache tables has different protection bit settings to virtualize guest system level access to a particular virtual address. Accordingly, when switching the guest user space to guest system level code, i.e. from guest user application code to guest kernel of guest operating system, or vice-versa then we need to switch the active copy of the paging cache tables from one to the other. Whilst this is not an expensive operation in terms of a single instruction it can be an expensive operation in terms of cache resets. The physical processor has a Translation Lookaside Buffer (TLB) which caches physical paging tables entry, which is already accessed by CPU, but can be accessed by any code, i.e. by application level code and by system level code. Switching the Paging Table root is an event for which the processor resets all mappings in the TLB.

The TLB enhances system performance as whilst for a first time access by the physical processor to a virtual page it may take about 50 ticks of CPU, because the processor has to read all entries from the paging tables from memory one by one and then check permissions for each instruction in microcode. However, once done then when the same page is accessed subsequently by executing another instructions this virtual page has been cached within the TLB and the translation is performed in one tick. Accordingly, each time we switch guest user level to guest kernel level, guest system level, we need to switch paging cache root and therefore reset the physical TLB. Whilst not ideal as the process controls both parts, the guest user code and guest system code translation, and accordingly the process can check current exception level in terms of ARM processes, current privilege level in terms of ×86 processes etc. such that is not a problem to decide which level of guest code should be executing currently and which copy of paging cache tables should be currently employed.

Another enhancement of the embodiment of the invention in FIGS. 5B and 5C over that within FIG. 5A is that we are running all of the guest user space and system level code on physical system level so that we have the option of employing fast emulation routines to access the privileged CPU state even when executing guest user mode code, translated guest user mode code.

Within FIGS. 5A to 5C embodiments of the invention employ kernel level helpers, referred to as fast emulation routines including the dispatcher. The dispatcher provides for fast handling without exiting to host operating system wherein the dispatcher handles exception, interrupts, and simulates guest exception and interrupts. Further, the dispatcher should have the ability to switch paging cache copies, switch guest levels, and use privileged instructions of the CPU.

Referring to FIG. 5B there is depicted a Computer System (Host) 5000 which has an overall structure similar to that of Host Computer System 500 in FIG. 5 except that the Virtualized Guest System Context 500 is now represented by Virtualized Guest System 5100 which is depicted in detail in FIG. 5C. As depicted in FIG. 5C the Virtualized Guest System 5100 comprises, in common with the Virtualized Guest System Context 560 in FIG. 5A, the Guest Native CPUs 4610, the Guest Applications 4620 the Fast Emulation Routines 520 of which part is the Dispatcher 525, the Translated Guest Code 530 and the Virtual Physical-to-Physical Translation 4640 which is mapped to the Physical RAM 4300 which is depicted for completeness as is the Binary Translation 5010.

The Guest Applications 4620 access User Paging Cache Tables 5110 (which are similar 5110 to Virtual Spaces (Paging Cache) 4630 in FIG. 5A which comprise the Translated Guest Code 530 and are mapped to the Virtual Physical-to-Physical Translation 4640 and therein Physical RAM 4300. Also mapped to the Virtual Physical-to-Physical Translation 4640 and therein Physical RAM 4300 are System Paging Cache Tables 5140 which are associated with the Guest Kernal Space Data 5120 and Guest Kernel Space Code 5130. As discussed above the embodiment of the invention implements a user level only virtualization with Translated Guest Code 530 being executed by the Guest Native CPUs 4610 directly or in conjunction with Fast Emulation Routines 520 where the Fast Emulation Routines 520 and Translated Guest Code 530 receive data from the Binary Translation 5010. The Translated Guest Code 530 is mapped to System Paging Cache Tables 5140 and User Paging Cache Tables 5110 (for the Guest Applications 4620). The Guest Native CPUs 4610 and Fast Emulation Routines 520/Translated Guest Code 530 also coupled to gCEL (virtualized guest current exception level for virtualized ARM platform) or gCPL (virtualized guest current privileged level for virtualized Intel or AMD platform) 5150 and therein to System Paging Cache Tables 5140 and User Paging Cache Tables 5110. The Binary Translation 5010 receives the code to translate from the Guest Kernal Space Code 5130 and User Space Code 5150.

Referring to Table 1 below the embodiments of the invention described and depicted with respect to FIGS. 5A and FIGS. 5B-5C are compared.

TABLE 1
Feature comparison of embodiments of the invention

| | | Single Level |
|---|---|---|
| | Multi-Level | Embodiment |
| | Embodiment | (FIGS. 5B |
| Feature | (FIG. 5A) | and 5C) |
| Native access to guest virtual address space | Yes | Yes |
| Native access to unprivileged guest CPU state w/o exits | Yes | Yes |
| to host | | |
| Native access to privileged guest CPU state w/o exits to | Guest system level | Yes |
| host context | only | |
| Switching paging cache tries regarding guest current | No | Yes |
| exception level / current privilege level | | |
| Using privileged host CPU registers in fast emulation | Guest system level | Yes |
| routines | only | |
| Maintain paging cache mappings in virtualized guest | Yes | Yes |
| system context | | |
| w/o exits to host | | |
| Fast emulation of guest virtual memory events (page | Yes | Yes |
| faults) w/o exits to host | | |

Native access to guest virtual address space: The embodiments of the invention organize the virtualized context to run translated code where we benefit from native space as we can organize paging cache in a manner as if it is native for guest operating system code, for translated guest operating system code, and a single memory access instruction of guest code can be represented with a small number of instructions to access the same virtual address. The virtualized context specially created for the guest operating system is native execution of virtual address space accesses.

Native access to unprivileged CPU state. The embodiments of the invention enhance upon the prior art depicted in FIG. 4B. In FIG. 4B binary translation was described running in host OS context which utilizes general purpose registers for its own purpose. However, within the embodiments of the invention depicted in FIGS. 5A and 5B the inventors expand the range of general purpose registers which can be accessed natively as there are no host requirements in the virtualized context.

Native access to privileged guest CPU state. Within embodiments of the invention according to FIG. 5B we can access from user space, user space code. However, in the case of multi-level, depicted in FIG. 5A, we just get system level only. Accordingly, for those fast emulation routines which should be executed, which should access privileged state, they can be executed only in the dispatcher, this running on system level.

Switching paging cache tries regarding guest current exception level/current privilege level. This does not exist within the multi-level system of FIG. 5A as there in only one copy of paging cache and accordingly protection bits are employed within the physical paging structures to protect particular virtual addresses. However, within the embodiment of FIG. 5B, single level, we need this selector which provides an additional check on switches between guest to host or between guest user space and guest system world. If the switch might affect extensive input/output (I/O) operations, for example, or extensive memory usage in guest operating system when there are a lot of functions from kernel OS or a lot of exceptions on interrupts serviced by guest operating system to simulate, for example, intensive disk I/O then each bus mastering request will be finished with a guest hardware interrupt. Therefore, if this interrupt happens in guest user space, we will require these switches and if access to disk is quite often, it will increase the a number of switches between guest user space to guest system space and the performance will be degraded on such scenarios. Accordingly, the single level embodiment of the invention addresses this through as everything is managed in a single level and switches are handled by swapping between the pair of paging cache tables.

Using privileged host CPU registers in fast emulation routines. As outlined above fast emulation routines cannot be employed to manage/access privileged host CPU registers within the multi-level system as the fast emulation routines are in the guest system level only. However, within the single level system they can as the host CPU registers are mapped within the user level and hence may be embedded within the fast emulation routines as a dispatcher visualization.

Maintain paging cache mappings within virtualized guest system context without exits to host.

All paging cache protection parts or re-mapping paging cache maintenance code can reside in our dispatcher in the virtualized context presented. Accordingly, we do not need to switch back to host operating system context to add entries, to add mappings to paging cache or delete entries in paging cache. As such it is a self-dependent structure which resides in virtualized guest system context and it is not necessary to exist to host.

Fast emulation of guest virtual memory events (page faults) without exits to host. Again, because we virtualized the whole system, whole process functionality, it also includes exceptions. For example, a page fault, which is organized by ordinary operating system by using page faults events. Every process in any operating system needs some memory, physical RAM memory, to keep the data on these physical pages. But physical memory is limited and accordingly the limits of the physical RAM memory will be exceeded. But any operating system should continue to work when memory is starved. Accordingly, within the prior art swapping was established where pages not accessed or rarely accessed are unmapped from the paging tables and saved to a non-volatile memory such as a hard disk drive and the corresponding page marked that has been swapped out.

Physically in paging structures, in the virtual context of each processor, it looks like the page is not present anymore, the so-called hardware bit P, the presence of a particular page, is reset to zero but guest application, it just allocated this page from heap (or by using anonymous mapping or memory-mapped file technique) and it still thinks that the page exists for the processor. Next time when the processor accesses this page, a physical exception, a page fault, will happen and an operating system patch fault handler will get control. It will check if page fault happened because of this memory was not allocated and if so will trigger so-called access violation termination for the process or software exception to the application and you will see crash of application. However, if this page was just swapped out, the execution of the process will be locked for the time when the kernel of the operating system will restore the particular page from the some non-volatile memory and place it within the paging structures reference to recover the physical page and put the reference set bit P in the paging structures to one. Then the kernel will restart user space execution from the same faulted instruction and it will just be repeated and will be executed natively without a second page fault arising.

Therefore, we should simulate such a page fault for proper behavior of guest operating system as well. Therefore, one of the features of embodiments of the invention is that we can handle these page faults in and simulate this page faults, these hardware exceptions. In our virtualized context this is achieved within the described dual page caching implementation via the dispatcher.

Accordingly, FIGS. 5B/5C embodiments of the invention are presented which are based upon the following design principles:
hardware assisted virtualization is used to isolating the guest architecture OS on all levels (kernel and application);
emulating guest architecture paging using host architecture paging as far as possible to get native guest virtual memory access in translated code;
execute all translated code (both kernel+application) on host kernel level using virtualization to secure and isolate the execution process;
use 2 paging cache tree copies for translated kernel and application levels to emulate memory spaces and protections where one copy of paging cache table entries have restrictions for simulating page protections when translated guest code is executed in guest kernel mode (gCEL is 1 for virtualized ARM platform or gCPL is 0, 1 or 2 for virtualized Intel/AMD platform) and the second copy is used when translated guest code is executed in guest user mode (gCEL is 0 or gCPL is 3). The number of paging cache tree copies can be extended if the virtualization system also simulates the hypervisor mode (gCEL=2) and/or the secure mode (gCEL=3);
using kernel level to run everything translated allows many checks to be simplified and privileged commands emulation to be implemented; and
no switches between kernel and application levels in translated code for faster execution.

Having 2 copies of paging cache tree for guest kernel and guest user space execution helps to implement mapping both guest kernel and user modes to real system level supporting access and modification of system registers used also in user space state virtualization. Therefore, virtualization of guest user mode does not require switches to privileged state to virtualize guest user space behavior-translated user space code already runs in privileged system mode. Thus, all virtualization subroutines like mapping/unmapping guest pages to paging cache, switches cached guest paging roots (e.g. by writing new paging cache tree root to CR3 on real Intel/AMD processor). This brings significant performance gain on virtualizing multiple guest processes of modern guest operating system.

Many of these design principles also apply to the design depicted in FIG. 5A of the other embodiment of the invention.

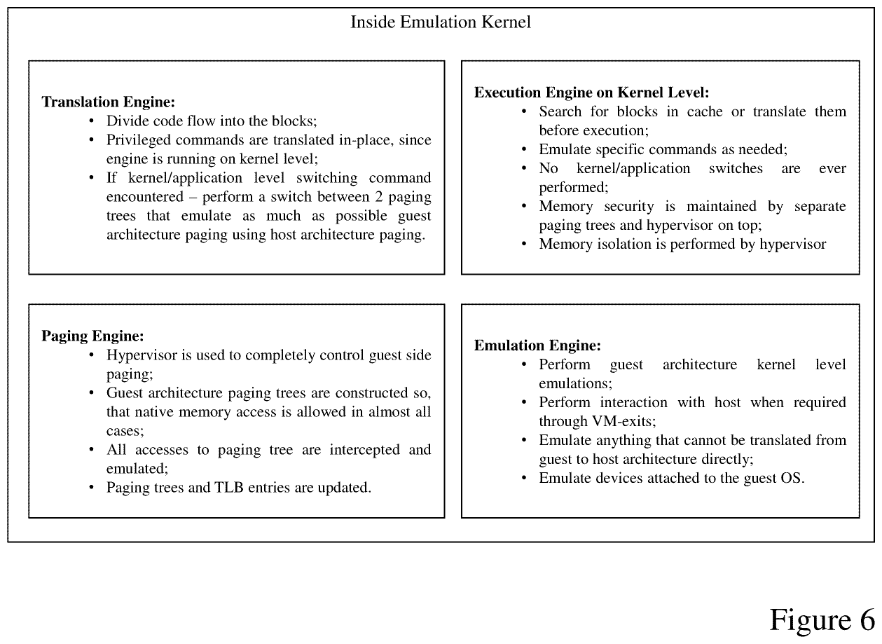

Now referring to FIG. 6 there is depicted schematically the depiction of four engines within the emulation kernel. These being a translation engine, aging engine, execution engine, and relation engine. The following description being with respect to the single context variant of the invention depicted in FIGS. 5B and 5C. For the multi-context variant in FIG. 5A minor modifications are made.

Accordingly, the translation engine translates the code and divides it into blocks where privileged commands are translated in place so that we do not have any switches between this user level, kernel level, or whatsoever as the translation engine is running in the kernel level. However, if a kernel layer/application layer switching command is encountered then it is undertaken in single place without any penalties for switching in general as the two paging structures emulate the guest paging architecture using host architecture paging. Should a context switch be required then it is performed where when we need to switch, we still need to switch this page entries, but it is okay because protections are employed to protect user space part from kernel space part so they do not have access to each other. Further, optimization of switching is undertaken so that the impact in terms of performance is minimized, where for example the process does not even flush the whole TLBs because we do not need to do so.

Next there is the paging engine which controls how the paging cache is formed. The main idea here is to have single memory access so that when we support another architecture, the main idea here is to have for one command, one command access in memory, we have the same one command that accesses the same address. Accordingly, the embodiments of the invention are constructed to be able to do so via the hypervisor level and everything associated with it such as hardware assisted binary translation and the virtualized guest system content. The underlying basis being that the system achieves complete translation of memory one-to-one. So we use the same address for both user space part and kernel space part and emulate other aspects to support different architectures where, for example, we have different page sizes. Within embodiments of the invention this is emulated by using a minimum possible page size for each architecture such that the system then emulates bigger pages as blocks of this smaller page.

Execution engine on kernel level, which is running in a small emulation kernel, referred to by the inventors as a dispatcher, which dispatches the execution. Accordingly, it searches for these blocks in cache or translates them and executes this loop where it is just getting the code, translating it or searching in cache for it, emulating some specific commands that cannot be translated and repeating. Of course, there are always commands that cannot be translated and these are emulated. Similarly, if there is the need to switch between kernel and application level then the engine pauses and restarts where it is now accessing a different paging cache table.

Memory security is maintained by separating page entries and by permissions. Accordingly, permissions are set up so that the user space translated code cannot access kernel translated code. If malicious code is executed inside the guest kernel then it will break this scheme and crash everything. Further, the use of the hypervisor on top of this is used for memory isolation completely so there is a complete address space for both user and kernel space memory and where possible exploit hardware optimization. Embodiments of the invention may exploit, for example, a Parallels hypervisor or it can exploit a special hypervisor framework, such as for example one implemented by Apple referred to as hypervisor framework which provides an API to organize the contexts for us and includes a user space API, user space libraries with API, a kernel level driver, and a hypervisor driver which allows to handle all these exception levels.

The emulation engine is used for everything that cannot be translated or needs to be emulated. This includes devices, virtual devices, virtual disks, networks etc. for example, so everything specific that needs to be emulated and is used for some specific comments that cannot be translated. The emulation engine is also used for switching to the host and interaction with the host when needed, such as we need to allocate memory or perform an action that requires interaction with the host. This is achieved via a VM exit when we need to exit from our space to our application etc. and is also required when starting, ending, pausing or suspending etc. The emulation engine is used for everything that cannot be translated but there are a lot of things, some comments that cannot be translated anyway. For example, a good example is floating point where on Intel we have 80-bit floating point hardware, floating point support but on ARM we do not have this and so we need to emulate it completely because we just cannot translate because there is nothing to translate. For example, for 64-bit floating point, we can combine comments from ARM to translate things in both ways as both architectures have support for 64-bit floating point, but 80-bit is only on Intel.

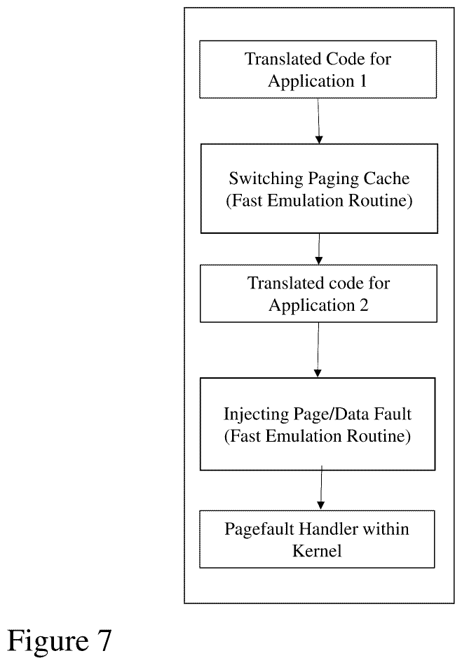

Now referring to FIG. 7 there is depicted schematically a visualization of the functions inside the code of an embodiment of the invention. The embodiments of the invention execute such you just translate something and when you need to do something that requires some direction, some privileged instruction, for example, emulation, or some access to some patient entries or whatever else, you just call some function, some helper function or fast emulation routine such as for rejecting exceptions, checking for interrupts, checking for paging data faults and other types of exceptions and some privileged comments that we can execute in place. So this is like a function that you call just executing normal code, just call the function and then continue to execute your code without any switches between user space and kernel space, without any switches going to host by hypervisor switching. So it is just executing in place, and even page entries are switching in place essentially as we swap from one paging table to another paging table within the same virtual space.

So, considering FIG. 7, then we are executing some code from one application, and then we need to switch to another application, we just do this switching in place. So we do not switch anything in terms of going to kernel and then switch there and then return back. The system will switch it in place by one or more of these helper functions. These helper functions can also include functions for checking distant translations, checking that there's time to inject an interrupt, for example, because we need to inject them, otherwise the guest will have bad latency and will not respond to user input. Further some relations like atomic operations or unaligned access simulations, they also require some specific things, and they sometimes they need to be emulated. Whilst these helper functions are not specifically part of the invention because some, for example, uses the same functions for the same purposes as known in the prior art, the underlying novel architecture presented is such that the system can do more in these functions because we do not need to switch anything. We can execute kernel code without any restrictions. Accordingly, it is possible to achieve better performance because we can do many things in place without any switching, we can use privileged operations, privileged memory accesses, and so on. So everything we need.

Similarly, even going to page fault handler in the kernel, in the guest kernel, code again takes no switching whatsoever as it is done in place and returned in place. Further, as these are performed in place then we can perform optimizations such as, for example, calling and returning optimizations, we just cache them, these addresses. This is possible within the single context embodiment as when employing the multi-context solution it is not always clear or known where the process will return to because you always switch things as you switch from user space to kernel space, from kernel space to user space. Within the single context we do not switch anything as everything is executed in a buffer, just in a big loop.

Within embodiments of the invention executing translated code on the kernel level makes it possible to use a range of helpers as indicated, including for example:
Checking, hooking and injecting exceptions, especially page/data fault accesses;
Perform paging trees switching “in place”;
Maintenance of paging cache without EL/ring switching (see above);
Checking for existing translations before code execution;
Emulation of commands requiring privileged instructions “in place”;
Simplified translations of EL/ring switching commands; and
Unaligned access emulation, if required by the architecture

With reference to FIGS. 4A to 4C and FIGS. 5A to 5C there are three kinds of lines employed. Dashed lines indicate mapping or physical reference between structures, between physical tables for example. Bold lines indicate dependence, software dependence between structures which can be usage or it can be referenced by pointer. Double line indicate access, access to memory or memory data.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other mediums capable of storing, containing, or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
creation of a hardware assisted virtualized environment for running incompatible guest operating system code by:
establishing native mapping of a guest virtual address space to virtual addresses of a host central processing unit (CPU); and
generating translated code for incompatible guest to native host instructions.

2. The method according to claim 1, further comprising
mapping guest code execution to a single kernel level context controlled by virtualization software within a hardware-assisted virtualization mode of the hardware assisted virtualized environment.

3. The method according to claim 1, further comprising
establishing a paging cache organization for an incompatible code architecture running under hardware assisted virtualization control upon a system comprising the host CPU executing host operating system code.

4. The method according to claim 1, wherein
the hardware assisted virtualized environment executes a process comprising:
passing guest application code from a virtualized guest operating system context to a hardware assisted binary translation module with a virtualizer application process;
the binary translated guest operating system code is then passed back to the virtualizer guest operating system context and therein to the guest CPU within the virtualizer guest system context.

5. The method according to claim 1, wherein
the binary translated guest operating system code is passed to the guest CPU via translated guest code and fast emulation routines;
the fast emulation routines comprises sets of translated code where each set of translated code comprises a block of translated sequential guest instructions as host instructions where the block of translated sequential guest instructions can be executed natively by the host CPU, repeating the behavior of guest code in terms of emulated structures; and
the translated guest code can make a call to or jump to a fast emulation routine of the fast emulation routines to perform a function or repeat a function.

6. The method according to claim 5, wherein
the binary translation is performed in the unprivileged space; and
the translations of guest operating code instructions to host operating instructions are stored within a cache of which a portion of the cache comprises the fast emulation routines.

7. The method according to claim 5, wherein
the fast emulation routines include a micro-virtualization kernel to handle page faults or exceptions during execution; and
the micro-virtualization kernel manages exceptions without an exit to the host operating system context.

8. The method according to claim 1, wherein
the hardware assisted virtualized environment establishes a virtualized guest system context which is executed two host CPU modes comprising a system level and a user level;
a single set of paging tables are employed; and
a user-superuser bit is employed within a paging descriptor of each paging table of the single set of paging tables in order to define a virtual address as at least one of available to or accessible by guest system level code, user level code or both the guest system level code and the user level code simultaneously.

9. The method according to claim 8, further comprising
establishing a dispatcher to manage access to or simulate access to a privileged state of the physical CPU when emulating a guest processor instruction which requires access to the privileged state of the physical CPU.

10. The method according to claim 1, wherein
all guest code instructions are translated to the host CPU architecture; and
two copies of paging cache tables are established where one copy of the paging cache tables maps pages and includes permission bits within the paging descriptors of the copy of the paging cache tables and the other copy of the paging cache tables has different protection bit settings to the copy of the paging cache tables to virtualize guest system level access to a particular virtual address.

11. The method according to claim 10, wherein
upon switching from a guest user space to a guest system level code, namely from guest user application code to guest kernel of guest operating system, or vice-versa a switch is performed as to which copy of the paging cache tables is the active copy of the paging cache tables.

12. A system comprising:
at least a host CPU; wherein
the host CPU supports creation of a hardware assisted virtualized environment for running incompatible guest operating system code by executing software instructions stored within a memory accessible to the host CPU which execute a process comprising:
establishing native mapping of a guest virtual address space to virtual addresses of a host CPU; and
translated code which is generated for incompatible guest to native host instructions.

13. The system according to claim 12, further comprising
software instructions stored within the memory for mapping guest code execution to a single kernel level context controlled by virtualization software within a hardware-assisted virtualization mode of the hardware assisted virtualized environment.

14. The system according to claim 12, further comprising
software instructions stored within the memory for establishing a paging cache organization for an incompatible code architecture running under hardware assisted virtualization control upon a system comprising the host CPU executing host operating system code.

15. The system according to claim 12, wherein
the hardware assisted virtualized environment executes a process comprising:
passing guest application code from a virtualized guest operating system context to a hardware assisted binary translation module with a virtualizer application process;
the binary translated guest operating system code is then passed back to the virtualizer guest operating system context and therein to the guest CPU within the virtualizer guest system context.

16. The system according to claim 15, wherein
the binary translated guest operating system code is passed to the guest CPU via translated guest code and fast emulation routines;
the fast emulation routines comprises sets of translated code where each set of translated code comprises a block of translated sequential guest instructions as host instructions where the block of translated sequential guest instructions can be executed natively by the host CPU, repeating the behavior of guest code in terms of emulated structures; and
the translated guest code can make a call to or jump to a fast emulation routine of the fast emulation routines to perform a function or repeat a function.

17. The system according to claim 15, wherein
the binary translation is performed in the unprivileged space; and
the translations of guest operating code instructions to host operating instructions are stored within a cache of which a portion of the cache comprises the fast emulation routines.

18. The system according to claim 15, wherein
the fast emulation routines include a micro-virtualization kernel to handle page faults or exceptions during execution; and
the micro-virtualization kernel manages exceptions without an exit to the host operating system context.

19. The system according to claim 12, wherein
the hardware assisted virtualized environment establishes a virtualized guest system context which is executed two host CPU modes comprising a system level and a user level;
a single set of paging tables are employed; and
a user-superuser bit is employed within a paging descriptor of each paging table of the single set of paging tables in order to define a virtual address as at least one of available to or accessible by guest system level code, user level code or both the guest system level code and the user level code simultaneously.

20. The system according to claim 19, further comprising
establishing a dispatcher to manage access to or simulate access to a privileged state of the physical CPU when emulating a guest processor instruction which requires access to the privileged state of the physical CPU.

21. The system according to claim 12, wherein
all guest code instructions are translated to the host CPU architecture; and
two copies of paging cache tables are established where one copy of the paging cache tables maps pages and includes permission bits within the paging descriptors of the copy of the paging cache tables and the other copy of the paging cache tables has different protection bit settings to the copy of the paging cache tables to virtualize guest system level access to a particular virtual address.

22. The system according to claim 21, wherein
upon switching from a guest user space to a guest system level code, namely from guest user application code to guest kernel of guest operating system, or vice-versa a switch is performed as to which copy of the paging cache tables is the active copy of the paging cache tables.
